(19) United States
(12) Patent Application Publication
(10) Pub. No.: US 2022/0144006 A1
(43) Pub. Date: May 12, 2022

(54) SECURITY DEVICE AND METHOD OF MANUFACTURE THEREOF

(71) Applicant: DE LA RUE INTERNATIONAL LIMITED, Basingstoke, Hampshire (GB)

(72) Inventor: John GODFREY, Basingstoke (GB)

(73) Assignee: DE LA RUE INTERNATIONAL LIMITED, Basingstoke, Hampshire (GB)

(21) Appl. No.: 17/438,330

(22) PCT Filed: Mar. 27, 2020
(86) PCT No.: PCT/GB2020/050836

§ 371 Date: Sep. 10, 2021

(30) Foreign Application Priority Data
Mar. 28, 2019 (GB) 1904333.0

(51) Int. Cl. B42D 25/387; B41M 3/14; B42D 25/342

(52) U.S. Cl. CPC B42D 25/387; B42D 25/342; B41M 3/144

(57) ABSTRACT

A security device includes a luminescent material arranged in a first region, wherein the material luminesces in response to irradiation one excitation wavelength wherein the first region exhibits a luminescent visible colour; an array of viewing elements; and a masking layer positioned between the decorative layer and the array of viewing elements, the masking layer partially overlaps with first region, including first pattern elements defined by the masking material, and second pattern elements defined by the absence of the masking material wherein the decorative layer is visible through the second pattern elements; the masking material is non-luminescing in response to one excitation wavelength, and when the security device illuminates by at least one wavelength, where the array of pattern elements overlaps with the first region, the second pattern elements exhibit the luminescent visible colour, and the first pattern elements exhibit a visual appearance that's different to the luminescent visible colour.

### FIELD OF THE INVENTION

This invention relates to security devices that may be used, for example, on documents of value such as banknotes, cheques, passports, identity cards, certificates of authenticity, fiscal stamps, and other secure documents, in order to confirm their authenticity. Methods of manufacturing such security devices are also disclosed.

### BACKGROUND TO THE INVENTION

Articles of value, and particularly documents of value such as banknotes, cheques, passports, identification documents, certificates and licences, are frequently the target of counterfeiters and persons wishing to make fraudulent copies thereof and/or changes to any data contained therein. Typically such objects are provided with a number of visible security devices for checking the authenticity of the object. By “security device” we mean a feature which it is not possible to reproduce accurately by taking a visible light copy, e.g. through the use of standardly available photocopying or scanning equipment. Examples include features based on one or more patterns such as microtext, fine line patterns, latent images, venetian blind devices, lenticular devices, moiré interference devices and moiré magnification devices, each of which generates a secure visual effect. Other known security devices include holograms, watermarks, embossings, perforations and the use of colour-shifting or luminescent inks. Common to all such devices is that the visual effect exhibited by the device is extremely difficult, or impossible, to copy using available reproduction techniques such as photocopying. Security devices exhibiting non-visible effects such as magnetic materials may also be employed.

One known class of security device are those which make use of luminescent substances (which term includes materials having fluorescent or phosphorescent properties). Such materials respond visibly to irradiation at certain wavelengths outside the visible spectrum, typically by emitting light of a particular colour characteristic of the material in question. The presence of such materials is therefore not readily detectable in normal illumination circumstances where the security device is illuminated with visible light only, but can be tested for by illuminating the security device with light of the appropriate wavelength, e.g. ultra-violet.

WO2004/050376 discloses examples of luminescent security devices having two regions which exhibit different colours under different viewing conditions. In preferred embodiments, the security device comprises two luminescent inks arranged in respective regions which have substantially the same visible colour when viewed under visible light, and both undergo a colour change to exhibit different visible colours (from one another) when viewed under a combination of visible light and UV. This is achieved for example by balancing, for each ink, the visible pigments against any visible colour of the luminescent substance(s) to make the two inks substantially match under visible illumination. The result is a security device with an enhanced, two-colour appearance under UV illumination.

Luminescent security features therefore provide a distinctive, high visual impact effect which is memorable and easily identified. However, luminescent inks are becoming more readily available on the commercial market and hence are accessible to would-be counterfeiters. As such, more complex luminescent features are needed to make counterfeiting more difficult and hence increase the security level.

### SUMMARY OF THE INVENTION

In accordance with a first aspect of the present invention, there is provided a security device comprising: a decorative layer comprising a luminescent material arranged in a first region, wherein the luminescent material luminesces in response to irradiation at at least one excitation wavelength such that the first region exhibits a luminescent visible colour when illuminated by said at least one excitation wavelength; an array of viewing elements; and, a masking layer comprising masking material positioned between the decorative layer and the array of viewing elements, the masking layer arranged as an array of pattern elements at least partially overlapping with said first region, and comprising first pattern defined by the presence of the masking material, and second pattern elements defined by the absence of the masking material such that the decorative layer is visible through the second pattern elements, wherein; the masking material is non-luminescing in response to the at least one excitation wavelength and is such that, when the security device is illuminated in the absence of the at least one excitation wavelength, at least where the array of pattern elements overlaps with the first region the first and second pattern elements have substantially the same visual appearance, and when the security device is illuminated by said at least one excitation wavelength, where the array of pattern elements overlaps with the first region, the second pattern elements exhibit the luminescent visible colour, and the first pattern elements exhibit a visual appearance that is different to the luminescent visible colour; and wherein, the array of pattern elements cooperates with the array of viewing elements such that when the security device is illuminated with the at least one excitation wavelength, the security device exhibits an optically variable effect.

The security device of the present invention therefore exhibits a different appearance under different lighting conditions (i.e. when illuminated by the at least one excitation wavelength, and when illuminated in the absence of the at least one excitation wavelength). When illuminated in the absence of the at least one excitation wavelength, the first and second pattern elements have substantially the same visual appearance, at least where the array of pattern elements overlaps with the first region. Consequently, under these lighting conditions, the security device does not exhibit an optically variable effect at least within the first region, with the appearance of the first region instead appearing “static”. Preferably the appearance of the device is a whole is not optically variable when illuminated in the absence of the at least one excitation wavelength. This is typically achieved by arrangements in which each of the first pattern elements is substantially transparent and colourless when illuminated in the absence of the at least one excitation wavelength, or located laterally within the first region.

Conversely, when the device is illuminated by the at least one excitation wavelength, the device exhibits an optically variable effect within the first region, examples of which will be explained in more detail below. Furthermore, depending on the full construction of the security device and/or how it is integrated within a security article of document, when viewed from the side of the device opposing the array of viewing elements, the first region will be visible with no accompanying optically variable effect (but with a change of colour under the change in illumination conditions). This provides a security device that exhibits a complex effect with high visual impact that is easy to authenticate and yet highly difficult to counterfeit. Herein, the term “optically variable effect” means that the security device exhibits a different visual appearance at different viewing angles, for example exhibiting different visual appearances as the security device is tilted. The exhibiting of an optically variable effect when illuminated by the at least one excitation wavelength provides an increased security level as compared to conventional security devices that have a different appearance under different illumination conditions, where the visual effects are typically “static”, i.e. not optically variable.

The difference between the effects exhibited by the device under different illumination conditions means that, when the security device is illuminated in the absence of the at least one excitation wavelength, the security device conveys a first piece of information, and when illuminated by the said at least one excitation wavelength, the optically variable effect exhibited by the device conveys a second piece of information, the first piece of information being different to the second piece of information. Here, by a change in information content we mean that the visual effects exhibited to an observer under the different illumination conditions differ by more than just colour.

The two different lighting conditions are defined by the presence or absence of the at least one excitation wavelength. Illumination in the absence of the at least one excitation wavelength preferably means illumination by visible light, which for the purposes of this specification refers to light having a wavelength in the visible spectrum, which is approximately 400 nm to 750 nm. It is most preferable that the visible light is white light, i.e. contains substantially all of the visible wavelengths in more or less equal proportion. The viewing condition “illuminated in the absence of the at least one excitation wavelength” may be referred to herein for brevity as “illumination by visible light”.

The at least one excitation wavelength is in the non-visible part of the electromagnetic spectrum, and is typically an ultra-violet (UV) wavelength, although may be an infra-red (IR) wavelength or other wavelength outside of the visible spectrum. The UV spectrum comprises wavelengths in the range of approximately 200 nm to 400 nm. Thus, typically, the at least one excitation wavelength is at least one UV wavelength in the range of 200 nm to 400 nm, preferably 235 nm to 380 nm. The at least one excitation wavelength may be substantially any UV wavelength in the range of 200 nm to 400 nm, preferably 235 nm to 380 nm. It is to be noted that in practice, when the security device is illuminated by the at least one excitation wavelength, the illumination conditions will typically include a combination of visible light and the at least one excitation (e.g. UV) wavelength. The viewing condition “illumination with the at least one excitation wavelength” may be referred to herein for brevity as “illumination by UV light”.

Throughout this specification, the term “visible colour” means a colour which can be seen by the naked human eye under the stated illumination conditions. This includes achromatic hues such as black, grey, white, silver etc., as well as chromatics such as red, blue, yellow, green, brown etc.

In embodiments, when illuminated in the absence of the at least one excitation wavelength, the first region may exhibit a non-luminescent visible colour. The term “non-luminescent visible colour” simply refers to the colour exhibited when viewed in the absence of the at least one excitation wavelength. Preferably, in such embodiments, the non-luminescent visible colour exhibited by the first region when illuminated in the absence of the at least one excitation wavelength is different to the luminescent visible colour exhibited by the first region when illuminated by said at least one excitation wavelength. However, they may be the same colour.

“Substantially the same” colours are those which appear the same as one another in a cursory inspection (by the naked human eye) although they may not be an exact match under close examination. By the same logic, “different” colours are those which clearly present a contrast to one another that is visible to the naked human eye even without a close inspection. The difference might be in terms of the colour's hue or tone or both.

For example, in preferred embodiments, two colours will be considered substantially the same as one another if the Euclidean distance ΔE*ab between them in CIELAB colour space (i.e. the CIE 1976 L*a*b* colour space) is less than 3, more preferably less than 2.3. The value of ΔE*ab is measured using the formula,

ΔE*_{ab}=\sqrt{(ΔL*)²+(Δa*)²+(Δb*)²}

where ΔL*, Δa* and Δb* are the distance between the two colours along the L*, a* and b* axes respectively (see “Digital Color Imaging Handbook” (1.7.2 ed.) by G. Sharma (2003), CRC Press, ISBN 0-8493-0900-X, pages 30 to 32). Conversely, if ΔE*ab is greater than or equal to 3 (or, in more preferred embodiments, greater than or equal to 2.3), the two colours will be considered different. The colour difference ΔE*ab can be measured using any commercial spectrophotometer, such as those available from Hunterlab of Reston, Va., USA.

In embodiments, when illuminated in the absence of the at least one excitation wavelength, the first region is substantially colourless, and as such may take the colour of any underlying layer or substrate. Such embodiments advantageously provide a particularly striking change in visual effect when undergoing a change in lighting conditions.

As has been discussed above, when the security device is illuminated in the absence of the at least one excitation wavelength, at least where the array of pattern elements overlaps with the first region, the first and second pattern elements have substantially the same visual appearance. As such, under these (e.g. visible light) illumination conditions, the security device exhibits a “static” visual effect, at least within the first region, and preferably over the lateral extent of the entire device. In preferred embodiments, when the masking material is illuminated in the absence of the at least one excitation wavelength, the masking material is substantially transparent and substantially colourless such that the decorative layer is visible through the first pattern elements. As such, the first pattern elements and second pattern elements have substantially the same visual appearance in the first region, and also within any region laterally outside the first region.

In other words, in such embodiments where the masking material is substantially transparent and colourless, both the first and second pattern elements take on the visual appearance of the decorative layer and hence exhibit substantially the same visual appearance. Consequently, when illuminated in the absence of the at least one excitation wavelength, the security device does not exhibit an optically variable effect. Preferably, each first pattern element is arranged laterally within the first region.

In alternative embodiments where the first region exhibits a non-luminescent visible colour when illuminated in the absence of the at least one excitation wavelength, each first pattern element is arranged laterally within the first region and, when illuminated in the absence of the at least one excitation wavelength, the masking material exhibits a non-luminescent visible colour that is substantially the same as the non-luminescent visible colour exhibited by the first region in the absence of the at least one excitation wavelength. As such, the first pattern elements and second pattern elements have substantially the same visual appearance in the first region. Furthermore, as there are no first pattern elements laterally outside the first region, the security device does not exhibit an optically variable effect when illuminated in the absence of the at least one excitation wavelength.

In accordance with a second aspect of the invention there is provided a security device comprising: a decorative layer comprising a luminescent material arranged in a first region, wherein the luminescent material luminesces in response to irradiation at at least one excitation wavelength such that the first region exhibits a luminescent visible colour when illuminated by said at least one excitation wavelength; an array of viewing elements; and, a masking layer comprising masking material positioned between the decorative layer and the array of viewing elements, the masking layer arranged as an array of pattern elements at least partially overlapping with said first region, and comprising first pattern elements defined by the presence of the masking material, and second pattern elements defined by the absence of the masking material such that the decorative layer is visible through the second pattern elements, wherein; the masking material exhibits a non-luminescent visible colour when illuminated in the absence of said at least one excitation wavelength, and is non-luminescing in response to the at least one excitation wavelength, and wherein, when the security device is illuminated in the absence of the at least one excitation wavelength, in at least one part of the security device, the first pattern elements exhibit a visual appearance that is different to a visual appearance exhibited by the second pattern elements, whereby the array of pattern elements cooperates with the array of viewing elements such that the security device exhibits a first optically variable effect, and, when the security device is illuminated by said at least one excitation wavelength, where the array of pattern elements overlaps with the first region, the second pattern elements exhibit the luminescent visible colour, and the first pattern elements exhibit a visual appearance that is different to the luminescent visible colour, whereby the array of pattern elements cooperates with the array of viewing elements such that the security device exhibits a second optically variable effect; and wherein, the arrangement of the first region and the array of pattern elements is such that the first optically variable effect conveys first information, and the second optically variable effect conveys second information that is different to the first information.

In the second aspect of the invention, the security device exhibits an optically variable effect both when illuminated in the absence of the at least one excitation wavelength, and when illuminated by the at least one excitation wavelength. However, the arrangement of the luminescent material in the first region, and the array of pattern elements, is such that the first optically variable effect (observed in visible light) and the second optically variable effect (observed in UV light) are different from one another. This provides a security device that exhibits a highly complex visual effect that is extremely difficult to counterfeit.

The first optically variable effect conveys first information and the second optically variable effect conveys second information that is different to the first information. This is due to the fact that the first and second optically variable effects differ by more than just perceived colour, and typically differ in image shape presented to the observer. For example, if the first optically variable effect comprised an “image switch” from a red square to a red circle on a change in viewing angle, and the second optically variable effect comprised an “image switch” from a blue square to a blue circle, in the context of the present invention, there would be no change in information content. If instead the second optically variable effect exhibited an “image switch” from a blue triangle to a blue circle, this change in image shape from the first optically variable effect provides a change in image content conveyed to the observer.

This change in information content provided by the present invention on a change in illumination conditions provides a significant improvement to conventional security devices that make use of luminescent materials, which typically simply exhibit a colour change (with no optically variable effect) on a change of illumination conditions.

The description relating to the at least one excitation wavelength, and the term “visible colour” outlined above in relation to the first aspect of the invention also apply to the second aspect.

In the second aspect of the invention, when the security device is illuminated in the absence of the at least one excitation wavelength, the masking material exhibits a non-luminescent visible colour and, in at least one part of the security device, the first pattern elements exhibit a visual appearance that is different to the visual appearance exhibited by the second pattern elements, such that the device exhibits a first optically variable effect. The first region (and indeed the whole of the decorative layer) may be substantially colourless when illuminated in the absence of the at least one excitation wavelength such that the non-luminescent visible colour of the masking material of the first pattern elements provides the required difference in visual appearance between the first and second pattern elements.

However, preferably, the first region exhibits a non-luminescent visible colour when illuminated in the absence of the at least one excitation wavelength. Thus, the array of pattern elements may define a second region, wherein the pattern elements within the second region cooperate with the array of viewing elements to exhibit an optically variable effect (e.g. at least in the absence of the at least one excitation wavelength), and wherein the second region is laterally completely contained within the first region, and wherein the first region exhibits a non-luminescent visible colour that is different to the non-luminescent visible colour exhibited by the masking material. In such embodiments, each first pattern element of the array of pattern elements is laterally completely contained within the first region, and in the absence of the at least one excitation wavelength exhibits a non-luminescent visible colour that is different to the non-luminescent visible colour exhibited by the first region. As such, in the part of the device where the array of pattern elements overlaps with the first region, the first pattern elements exhibit a different visual appearance (i.e. different colour) to the second pattern elements, which exhibit the non-luminescent visible colour of the first region.

The second region is typically in the form of indicia or an indicium, preferably one or more geometric shapes, letters, numbers, logos, currency signs or other symbols that is perceivable in the first optically variable effect.

In other embodiments, the array of pattern elements may define a second region, wherein the pattern elements within the second region cooperate with the array of viewing elements to exhibit an optically variable effect (e.g. at least in the absence of the at least one excitation wavelength), and wherein the second region laterally extends beyond the first region in at least a part of the device.

In such embodiments, although as discussed above the first region may be substantially colourless when illuminated in the absence of the at least one excitation wavelength, in preferred embodiments, when illuminated in the absence of the at least one excitation wavelength, the first region exhibits a non-luminescent visible colour. The non-luminescent colours exhibited by the first region and the masking material may be substantially the same, in which case the first optically variable effect is apparent in the part of the device where the second region laterally extends beyond the first region. Alternatively, the non-luminescent colours exhibited by the first region and the masking material may differ from each other, such that the first optically variable effect is apparent across the whole of the second region.

In embodiments where the second region defined by the array of pattern elements laterally extends beyond the first region in at least a part of the device, the second region is typically in the form of indicia or an indicium, preferably one or more geometric shapes, letters, numbers, logos, currency signs or other symbols that is perceivable in the first optically variable effect, that is at least partially perceivable in the first optically variable effect.

In examples of the second aspect, the first and second regions complement each other. This is particularly the case when the device is viewed in the absence of the at least one excitation wavelength and wherein the first region exhibits a non-luminescent visible colour. For example, the first and second regions may combine together such that the security device exhibits indicia or an indicium that is different to the indicia or indicium defined by the first and second regions in isolation.

Typically, the masking layer comprises a single masking material. In other words, each first pattern element is formed from the same masking material such that they each exhibit the same visual effects under the different lighting conditions. However, in yet further embodiments, the masking layer may comprise at least first and second masking materials such that some first pattern elements comprise the first masking material and some first pattern elements comprise the second masking material, the first and second masking materials having different optical properties when illuminated in the absence of the at least one excitation wavelength. Some first pattern elements may comprise both the first and second masking materials. Preferably, the first masking material exhibits a non-luminescent visible colour and the second masking material is substantially transparent and colourless in the absence of the at least one excitation wavelength, although the first and second masking materials may exhibit different non-luminescent visible colours. This allows the provision of further complex visual effects. The at least first and second masking materials are preferably configured in sub-regions of the second region.

In the present invention, preferably, the decorative layer comprises an ink arranged in said first region, the ink comprising said luminescent material. The luminescent material used in the present invention is typically a fluorescent and/or phosphorescent material. Herein the term “ink” is used to refer to a composition comprising a binder carrying appropriate materials to exhibit the desired effects. Typically the decorative layer is formed of such an ink, and may be formed of a plurality of inks in order to provide complex visual effects such as multi-coloured images, which will be discussed in more detail below.

Typically, unless the luminescent material has the desired body colour, the ink may further comprise an optically detectable material that exhibits a non-luminescent visible colour when illuminated in the absence of the at least one excitation wavelength. Such optically detectable materials may be non-luminescent pigments and/or dyes for example, in order to create the desired colour in visible light. WO2004/050376 discloses examples of ink compositions suitable for use in the security device of the present invention, and further examples of appropriate inks will be given below.

In alternative embodiments where such further optically detectable materials such as non-luminescent pigments and/or dyes are used, these may be provided separately to the luminescent material. For example the first region may comprise two more inks overlapping each other (preferably in register), with one ink containing a luminescent material, and another ink providing a non-luminescent visible colour.

In the present invention, the decorative layer comprises a luminescent material arranged in a first region. The first region may extend laterally substantially completely across the device. In other embodiments the first region may extend across only part of the device such that the decorative layer comprises zone(s) laterally outside of the first region where no luminescent material is present. In embodiments the first region may be in the form of indicia or an indicium, preferably one or more geometric shapes letters, numbers, logos, currency signs or other symbols.

In general, the decorative layer is configured so as to exhibit a first colour image when illuminated by the at least one excitation wavelength. In embodiments where the first region is in the form of indicia or an indicium, the decorative layer is configured in the form of an image arising from the shape of the first region. In preferred embodiments, the decorative layer is configured so as to also exhibit second colour image when illuminated in the absence of the at least one excitation wavelength. In the same manner, such a second colour image may arise from the shape of the first region.

The first and/or second image may be of a single uniform colour, or comprise a monochromatic or multi-coloured image with any level of complexity. For example, the first and/or second image may be a uniform block of colour, or could be a complex colour photograph such as a passport photograph.

Preferably, the first and/or second colour image is in the form of a multi-coloured image, and wherein the decorative layer comprises a plurality of inks that exhibit visible colours that are different to each other when the device is illuminated by the at least one excitation wavelength and/or when illuminated in the absence of the at least one excitation wavelength, said plurality of inks forming the multi-coloured image. For example, the decorative layer may comprise four inks that provide CMYK colour mixing that provides a complex colour image at least under some illumination conditions.

The first and second images may be substantially the same, or the first and second images may be different.

It should be noted that when the first and/or second image is in the form of a complex colour image such as a photograph, the first region typically laterally extends substantially completely across the array of pattern elements, and preferably across the whole device.

The first region preferably has a size substantially greater than a pitch of the array of viewing elements such that the first region substantially does not interact with the array of viewing elements. In other words, if the device were to be viewed without the masking layer, it would exhibit substantially the same visual appearance at substantially all viewing angles. Hence, the optically variable effect(s) exhibited by the security device under a given illumination condition is provided by the interaction of the array of pattern elements and the array of viewing elements.

As has been discussed above, the masking material is non-luminescing in response to the at least one excitation wavelength. This simply means that it does not exhibit a luminescent visible colour upon illumination with the at least one excitation wavelength. The masking material will therefore appear dark under UV light, although it will be understood that the appearance of the masking material does not constitute a “luminescent visible colour” within the meaning of this specification as its appearance does not depend on the luminescence mechanism. Preferably, the masking material substantially absorbs radiation of the at least one excitation wavelength. In other words, when the security device is illuminated by the at least one excitation wavelength, the masking material appears substantially black. Consequently, where the array of pattern elements overlaps with the first region, when illuminated by the at least one excitation wavelength, the first pattern elements (which comprise masking material) exhibit a different visual appearance to the second pattern elements which take on the visual appearance of the first region which is visible through said second pattern elements. The masking material preferably substantially absorbs radiation of the same wavelength(s) that the luminescent material luminesces in response to.

The masking material preferably comprises one or more substances that substantially absorb radiation of the at least one excitation wavelength. This advantageously means that the masking material can be applied (e.g. printed) with a low coat weight and will absorb (block) radiation of the at least one excitation wavelength such that the optically variable effect is generated. The low coat weight means that pattern elements with dimensions of 50 microns or less, preferably 30 microns or less, more preferably 20 microns or less, still preferably 10 microns or less, most preferably 5 microns or less can be used, giving rise to complex patterns and corresponding optically variable effects.

Suitable substance(s) that may be used in the masking material include Hydroxybenzophenone, such as 2-hydroxy-benzophenone, 2-(3′-tert-butyl-2′-hydroxy-5′-methylphenyl)-5-chlorobenzotriazole (CAS #: 3896-1 1-5), available commercially as Tinuvin 326 or Omnistab 326; or pyrrolo[3,4-f]benzotriazole-5,7(2H,6H)-dione, 6-butyl-2-[2-hydroxy-3-(1-methyl-1-phenylethyl)-5-(1,1,3,3-tetramethylbutyl)phenyl]- (CAS #945857-19-2) available commercially as Tinuvin CarboProtect or CHISORB® 5431.

Other suitable substances include hydroxyphenylbenzotriazole, such as 2-(2-hydroxyphenyl)-benzotriazoles, hydroxyphenyl triazines exemplified by 2-(4,6-diphenyl-1,3,5-triazin-2-yl)- 5-[(hexyl)oxy]-phenol, (CAS #147315-50-2) available commercially as Tinuvin 1577; or the mixture of 2-[4-[2-hydroxy-3-tridecyl (and dodecyl) oxypropyl]oxy]-2-hydroxyphenyl]-4,6-bis(2,4-dimethylphenyl)-1,3,5-triazine (CAS #153519-44-9) available commercially as Tinuvin 400; benzophenones and benzotriazoles, such as hydroxybenzophenones exemplified by 2-hydroxy-4- octyloxybenzophenone (CAS #1843-05-6) available commercially as Uvinul 3008; or 2,2′-dihydroxy-4,4′-dimethoxy benzophenone (CAS #131-54-4) available commercially as Uvinul D49 and Cyasorb UV.

Further suitable substances include diaryl cyanoacrylates include ethyl-2-cyano-3,3-diphenylacrylate (CAS #5232-99-5) commercially available as Uvinul 3035; and 1,3-bis-[(2′-cyano-3,3,-diphenylacryloyl)oxy]-2,2-bis-{[(2,-cyano-3,3′-diphenylacryloyl)oxy]methyl}-propane (CAS #178671-58-4) commercially available as Uvinul 3030.

Hydroxyphenyltriazines, oxanilides, carbon black and rutile titanium oxide and transparent Iron oxide may also be used.

Typically the masking material absorbs substantially all wavelengths in the UV part of the electromagnetic spectrum.

Preferably, the masking material is an ink. In other words, in preferred embodiments, the masking material is in the form of an ink that comprises a suitable substance that substantially absorbs the at least one excitation wavelength. The masking material (e.g. ink) also has the desired properties in visible light, e.g. transparent and colourless or exhibiting a non-luminescent visible colour. The masking layer may comprise two different inks exhibiting different optical properties, as discussed above.

In the present invention, the array of pattern elements cooperates with the array of viewing elements such that the security device exhibits an optically variable effect, at least when illuminated with the at least one excitation wavelength. The nature of the array of pattern elements will depend upon the type of optically variable effect the device is desired to exhibit. The security device may exhibit an optically variable effect based on a moiré magnification, integral imaging or lenticular mechanisms, as will now be discussed. In security devices according to the second aspect which exhibit optically variable effects in both the presence and absence of the at least one excitation wavelength, the first and second optically variable effects will exploit the same mechanism, and so the following discussion applies to both the first and second optically variable effects exhibited by such devices. Thus, the optically variable effects discussed below may be exhibited when the device is illuminated by the at least one excitation wavelength (for the both the first and second aspects of the invention), and when illuminated in the absence of the at least one excitation wavelength (for the second aspect of the invention).

Moiré magnifier devices (examples of which are described in EP-A-1695121, WO-A-94/27254, WO-A-2011/107782 and WO2011/107783) make use of an array of viewing elements (such as lenses or mirrors) and a corresponding array of microimages, wherein the pitches of the viewing elements and the array of microimages and/or their relative locations are mismatched with the array of viewing elements such that a magnified version of the microimages is generated due to the moiré effect. Each microimage is a complete, miniature version of the image which is ultimately observed, and the array of viewing elements acts to select and magnify a small portion of each underlying microimage, which portions are combined by the human eye such that the whole, magnified image is visualised. This mechanism is sometimes referred to as “synthetic magnification”. The magnified array appears to move relative to the device upon tilting and can be configured to appear above or below the surface of the device itself. The degree of magnification depends, inter alia, on the degree of pitch mismatch and/or angular mismatch between the viewing element array and the microimage array.

Integral imaging devices are similar to moiré magnifier devices in that an array of microimages is provided under a corresponding array of lenses, each microimage being a miniature version of the image to be displayed. However here there is no mismatch between the lenses and the microimages. Instead a visual effect is created by arranging for each microimage to be a view of the same object but from a different viewpoint. When the device is tilted, different ones of the images are magnified by the lenses such that the impression of a three-dimensional image is given.

“Hybrid” devices also exist which combine features of moiré magnification devices with those of integral imaging devices. In a “pure” moiré magnification device, the microimages forming the array will generally be identical to one another. Likewise in a “pure” integral imaging device there will be no mismatch between the arrays, as described above. A “hybrid” moiré magnification/integral imaging device utilises an array of microimages which differ slightly from one another, showing different views of an object, as in an integral imaging device. However, as in a moiré magnification device there is a mismatch between the viewing element array and the microimage array, resulting in a synthetically magnified version of the microimage array, due to the moiré effect, the magnified microimages having a three-dimensional appearance. Since the visual effect is a result of the moiré effect, such hybrid devices are considered a subset of moiré magnification devices for the purposes of the present disclosure. In general, therefore, the microimages provided in a moiré magnification device should be substantially identical in the sense that they are either exactly the same as one another (pure moiré magnifiers) or show the same object/scene but from different viewpoints (hybrid devices).

Moiré magnifiers, integral imaging devices and hybrid devices can all be configured to operate in just one dimension (e.g. utilising cylindrical lenses) or in two dimensions (e.g. comprising a 2D array of spherical or aspherical lenses).

Lenticular devices on the other hand do not rely upon magnification, synthetic or otherwise. An array of viewing elements, typically cylindrical lenses or a masking grid, overlies a corresponding array of image sections, or “slices”, each of which depicts only a portion of an image which is to be displayed. Image sections from two or more different images are interleaved and, when viewed through the viewing elements, at each viewing angle, only selected image segments will be directed towards the viewer. In this way, different composite images can be viewed at different angles. However it should be appreciated that no magnification typically takes place and the resulting image which is observed will be of substantially the same size as that to which the underlying image segments are formed. Some examples of lenticular devices are described in U.S. Pat. No. 4,892,336, WO-A-2011/051669, WO-A-2011051670, WO-A-2012/027779 and U.S. Pat. No. 6,856,462. More recently, two-dimensional lenticular devices have also been developed and examples of these are disclosed in British patent application numbers 1313362.4 and 1313363.2. Lenticular devices have the advantage that different images can be displayed at different viewing angles, giving rise to the possibility of animation and other striking visual effects which are not possible using the moiré magnifier or integral imaging techniques.

Typically the pattern of first and second pattern elements includes pattern elements with a minimum dimension of 50 microns or less, preferably 30 microns or less, more preferably 20 microns or less, still preferably 10 microns or less, most preferably 5 microns or less.

In preferred examples, the array of first and second pattern elements is periodic in at least a first dimension and preferably either the first pattern elements are identical to one another and/or the second pattern elements are identical to one another. Such an array is suitable for use in moiré magnification devices, integral imaging devices and certain types of lenticular device. Here, by “substantially identical”, we include microimages which depict the same object or scene as one another but from different angles of view (which are typically used in integral imaging devices for example).

For lenticular devices, the array of pattern elements may cooperate with the array of viewing elements such that each viewing element can direct light from a respective one of the first pattern elements or from a respective one of the second pattern elements therebetween in dependence on viewing angle, whereby depending on the viewing angle the array of viewing elements directs light from either the first pattern elements which comprise masking material, or from the second pattern elements therebetween in which the masking material is absent, such that, as the device is tilted, light from the luminescent material is exhibited to the viewer through the second pattern elements in combination at a first range of viewing angles and not at a second range of viewing angles.

In such devices the periodicity of the viewing element array is substantially equal to or a multiple of that of the array of first and second pattern elements.

The device may be a two-channel lenticular device. Preferably, the array of first and second pattern elements is a line pattern (although other patterns such as “dot” patterns are envisaged), periodic in the first dimension which is perpendicular to the direction of the lines, the line pattern preferably being of straight parallel lines, and the width of the lines preferably being substantially equal to the spacing between the lines. The appearance generated by the first pattern elements corresponds to one channel of the device and that by the second pattern elements to the second channel.

As discussed above, the second pattern elements are defined by the absence of masking material, such that the decorative layer is visible through the second pattern elements and thus the second pattern elements take on the form of the decorative layer. Thus, the second channel corresponds to the decorative layer, which will be exhibited at the second range of viewing angles. Thus, for example if the decorative layer is in the form of a colour image, this will be exhibited to an observer at the second range of viewing angles. At the first range of viewing angles, the decorative layer will be “masked” by the masking material of the first pattern elements (the first pattern elements themselves corresponding to the first channel of the device). This generates a striking “image reveal” effect.

In the case of the first and second pattern elements being arranged as a line pattern as discussed above, the lenticular pattern is active in one dimension (i.e. upon tilting the device about one axis). In embodiments, the lenticular device may be active in two dimensions—that is, displaying an optically variable effect when the device is tilted about two (preferably orthogonal) axes. In this case, the array of first and second pattern elements is preferably a grid pattern, periodic in the first dimension and in a second dimension, wherein the grid pattern is preferably arranged on an orthogonal or hexagonal grid, the grid pattern preferably being of dots arranged according to the grid, most preferably square, rectangular, circular or polygonal dots. The grid pattern may constitute a checkerboard pattern for example.

For other lenticular devices, the array of pattern elements may be more complex. For instance, the first pattern elements can be configured to provide parts of multiple images, with the second pattern elements providing the remaining parts of each of those images, or vice-versa. In preferred examples, the array of first and second pattern elements defines sections of at least two images interleaved with each other periodically in at least a first dimension. Each image section typically has width of 50 microns or less in at least the first dimension, more preferably 30 microns or less, most preferably 20 microns or less. It should be noted in that in such cases the first and second pattern elements themselves may not be arranged periodically since their locations will be defined by the first and second images.

In preferred examples of such devices, the array of first and second pattern elements cooperates with the array of viewing elements such that each viewing element can direct light from a respective one of the first image sections or from a respective one of the second image sections therebetween in dependence on viewing angle, whereby depending on the viewing angle the array of viewing elements directs light either from the array of first image sections or from the array of second image sections therebetween, such that, as the device is tilted when illuminated by the at least one excitation wavelength, the first image is displayed to the viewer by the first image sections in combination at a first range of viewing angles, and the second image is displayed to the viewer by the second image sections in combination at a second, different, range of viewing angles. More than two images may be interleaved in this manner to provide more complex effects.

The security device of the present invention may be a moiré magnification device (including hybrid moiré magnifier/integral imaging devices). In such devices, preferably the first pattern elements define microimages and the second pattern elements define a background, or vice-versa, such that the array of pattern elements defines a microimage array, and the pitches of the array of viewing elements and of the microimage array and their relative orientations are such that the array of viewing elements cooperates with the microimage array to generate a magnified version of the microimage array due to the moiré effect. Typically the microimages are substantially identical to each other, with the microimages typically comprising one or more letters, logos or other symbols.

For devices the exhibit an integral imaging optically variable effect, preferably the first pattern elements define microimages all depicting the same object from a different viewpoint and the second pattern elements define a background, or vice-versa, such that the array of pattern elements defines a microimage array, and the pitches and orientation of the array of viewing elements and of the microimage array are the same, such that the array of viewing elements cooperates with the microimage array to generate a magnified, optically variable version of the object.

For moiré magnifier and integral imaging devices, the microimages are preferably arranged in a grid pattern, periodic in a first dimension and second dimension, and wherein the grid pattern is preferably arranged on an orthogonal or hexagonal grid.

The array of viewing elements preferably comprises an array of focussing elements, preferably lenses. In preferred examples, the focussing element array has a one- or two-dimensional periodicity in the range of 5-200 microns, preferably 10-70 microns and most preferably 20-40 microns.

The focussing elements may be adapted to focus light in one dimension (e.g. for one dimensional optically variable effects), in which case the focussing elements are preferably cylindrical focussing elements. The focussing elements may be adapted to focus light in at least two orthogonal directions (e.g. for two dimensional optically variable effects), in which case the focussing elements are preferably spherical or aspherical focussing elements.

In order for the security device to generate a focussed image, preferably the masking layer is located approximately in the focal plane of the array of focussing elements. Preferably, the decorative layer is also preferably located approximately in the focal plane of the array of focussing elements.

For lenticular devices, as will be understood by the skilled person, preferably the periodicity of the array of focussing elements is substantially equal to or a multiple of that of the array of pattern elements (e.g. the periodicity of the arrangement of first and second pattern elements or periodicity of image sections).

In alternative embodiments, the array of viewing elements is in the form of a masking grid. In such embodiments, preferably each viewing element comprises a region that is substantially opaque to at least the at least one excitation wavelength (preferably also opaque to visible light), and a region that is substantially transparent to the at least one excitation wavelength (preferably also transparent to visible light).

The security device typically further comprises a substantially transparent substrate, preferably wherein the masking layer and decorative layer are provided on a first surface of said substrate, and the array of viewing elements is provided on a second opposing surface of said substrate. In such cases the substrate thickness provides the desired optical spacing between the viewing elements and the masking layer and decorative layer. However, other arrangements of the masking layer, decorative layer and array of viewing elements are envisaged (e.g. all on the same surface of the substrate), so long as the masking layer is positioned between the decorative layer and the array of viewing elements. Preferred materials for such a transparent substrate include BOPP, PET and polycarbonate. The substrate may be monolithic or multi-layered.

Typical thicknesses for such a substrate are in the range of 9-150 microns, preferably 12-100 microns. The substrate may be a substrate of a security thread for a banknote, a banknote substrate itself, or a polycarbonate sheet for lamination into a data page, for example. Such a data page (e.g. for a security document such as a passport) typically comprises a plurality of polycarbonate sheets that are laminated together (with a total thickness of approximately 600 microns). The masking layer, decorative layer and array of viewing elements may be provided on the same sheet that is laminated into the data page; or alternatively the masking layer and decorative layer may be applied to one sheet, with the array of viewing elements applied to a different sheet such that the desired optical spacing is achieved in the finished data page. It is noted that the terminology “on a surface” does necessarily mean “in direct contact” with that surface, and a layer may be described as applied “on a surface” even if one or more further layer exist between it and the substrate surface. Thus, in such latter examples, the masking layer, decorative layer and array of viewing elements are considered to be provided on opposing sides of the same substrate.

The security device of the present invention may further comprise a substantially opaque backing layer on a distal side of the decorative layer to the masking layer, the backing layer preferably laterally extending substantially completely across the array of pattern elements. The backing layer is typically opaque to at least the at least one excitation wavelength, and visible light.

The substantially opaque backing layer improves the appearance of the optically variable effect exhibited by the device by substantially blocking the transmission of light through the decorative layer and masking layer that may otherwise confuse the visual effect generated by the device.

In embodiments, the security device may comprise a reference region that exhibits a reference optically variable effect when illuminated in the absence of the at least one excitation wavelength, preferably wherein the reference optically variable effect is substantially identical to the optically variable effect exhibited by the device when illuminated by the at least one excitation wavelength (e.g. may be considered as conveying substantially the same information content). The reference region typically does not comprise any luminescent material and as such does not exhibit an optically variable effect when illuminated by the at least one excitation wavelength (typically appearing dark).

Preferably the reference region is laterally spaced from the arrangement of the decorative layer, masking layer and array of viewing elements discussed above, and the optically variable effects exhibited under the different lighting conditions may be compared with each other in order to indicate authenticity. The reference region comprises at least an array of pattern elements and an array of viewing elements that overlap each other and cooperate so as to exhibit an optically variable effect when illuminated in the absence of the at least one excitation wavelength. The decorative layer, array of viewing elements and masking layer of the device as described above may comprise regions that cooperate (overlap) to form the reference region of such a security device.

In accordance with a third aspect of the present invention, there is provided a method of manufacturing a security device, comprising: (i) providing a substantially transparent substrate; and, (ii) applying a masking layer, decorative layer and an array of viewing elements to the substrate such that the masking layer is positioned between the decorative layer and the array of viewing elements, and the array of viewing elements overlaps with the masking layer, and wherein; the decorative layer comprises a luminescent material arranged in a first region, wherein the luminescent material luminesces in response to irradiation at at least one excitation wavelength such that the first region exhibits a luminescent visible colour when illuminated by said at least one excitation wavelength; the masking layer comprises masking material and is arranged as an array of pattern elements at least partially overlapping with said first region, and comprises first pattern elements defined by the presence of the masking material, and second pattern elements defined by the absence of the masking material such that the decorative layer is visible through the second pattern elements, wherein; the masking material is non-luminescing in response to the at least one excitation wavelength and is such that, when the security device is illuminated in the absence of the at least one excitation wavelength, the first and second pattern elements have substantially the same visual appearance, and when the security device is illuminated by said at least one excitation wavelength, where the array of pattern elements overlaps with the first region, the second pattern elements exhibit the luminescent visible colour, and the first pattern elements exhibit a visual appearance that is different to the luminescent visible colour; and wherein, the array of pattern elements cooperates with the array of viewing elements such that when the security device is illuminated with the at least one excitation wavelength, the security device exhibits an optically variable effect.

The method of the third aspect of the invention therefore advantageously provides a security device having the advantages described above with respect to the first aspect of the invention. The method may be adapted to manufacture a security device according to any of the preferred examples discussed above in relation to the first aspect of the invention.

In accordance with a fourth aspect of the invention there is provided a method of manufacturing a security device, comprising: (i) providing a substantially transparent substrate; and, (ii) applying a masking layer, decorative layer and an array of viewing elements to the substrate such that the masking layer is positioned between the decorative layer and the array of viewing elements, and the array of viewing elements overlaps with the masking layer, and wherein; the decorative layer comprises a luminescent material arranged in a first region, wherein the luminescent material luminesces in response to irradiation at at least one excitation wavelength such that the first region exhibits a luminescent visible colour when illuminated by said at least one excitation wavelength; the masking layer comprises masking material and is arranged as an array of pattern elements at least partially overlapping with said first region, and comprises first pattern elements defined by the presence of the masking material, and second pattern elements defined by the absence of the masking material such that the decorative layer is visible through the second pattern elements, wherein; the masking material exhibits a non-luminescent visible colour when illuminated in the absence of said at least one excitation wavelength and is non-luminescing in response to the at least one excitation wavelength, and wherein, when the security device is illuminated in the absence of the at least one excitation wavelength, in at least one part of the security device, the first pattern elements exhibit a visual appearance that is different to a visual appearance exhibited by the second pattern elements, whereby the array of pattern elements cooperates with the array of viewing elements such that the security device exhibits a first optically variable effect, and, when the security device is illuminated by said at least one excitation wavelength, where the array of pattern elements overlaps with the first region, the second pattern elements exhibit the luminescent visible colour, and the first pattern elements exhibit a visual appearance that is different to the luminescent visible colour, whereby the array of pattern elements cooperates with the array of viewing elements such that the security device exhibits a second optically variable effect; and wherein, the arrangement of the first region and the array of pattern elements is such that the first optically variable effect conveys first information, and the second optically variable effect conveys second information that is different to the first information.

The method of the fourth aspect of the invention therefore advantageously provides a security device having the advantages described above with respect to the second aspect of the invention. The method may be adapted to manufacture a security device according to any of the preferred examples discussed above in relation to the second aspect of the invention.

The following description will refer to the methods of both the third and fourth aspects of the invention.

In preferred examples, in step (ii) the masking layer and decorative layer are applied on a first surface of said substrate, and the array of viewing elements is provided on a second opposing surface of said substrate. It is noted that the terminology “on a surface” does necessarily mean “in direct contact” with that surface, and a layer may be described as applied “on a surface” even if one or more further layer exist between it and the substrate surface.

Preferably, the decorative layer comprises an ink arranged in said first region, the ink comprising said luminescent material. Preferred methods of applying the decorative layer are by printing, coating or lamination, optionally in more than one working, preferably by any of: laser printing, inkjet printing, lithographic printing, gravure printing, flexographic printing, intaglio printing, screen printing, letterpress or dye diffusion thermal transfer printing.

In preferred examples, the masking material comprises one or more substances that substantially absorb radiation of the at least one excitation wavelength, preferably wherein the masking material is an ink. The masking material is typically applied by printing, preferably any of: laser printing, inkjet printing, lithographic printing, gravure printing, flexographic printing, intaglio printing, screen printing letterpress or dye diffusion thermal transfer printing.

The array of viewing elements may comprise an array of focussing elements, preferably lenses. Such focussing elements are typically provided by thermal embossing or cast curing. In other embodiments, the array of viewing elements may be in the form of a masking grid, the masking grid being provided by printing, preferably any of: laser printing, inkjet printing, lithographic printing, gravure printing, flexographic printing, intaglio printing, screen printing, letterpress or dye diffusion thermal transfer printing. In embodiments where the focussing elements are provided by cast curing using UV radiation as the curing radiation, it is preferred (although not essential) to apply the focussing elements before application of the masking layer and decorative layer. This ensures that the masking material does not interfere with the cast curing process forming the focussing elements.

The method of either the third or fourth aspects of the invention may comprise applying a substantially opaque backing layer to the substrate such that the backing layer is positioned on a distal side of the decorative layer to the masking layer, the backing layer preferably laterally extending substantially completely across the array of pattern elements. This provides a security device having the advantages as set out above. The backing layer is typically applied after application of the decorative layer on the same surface of the substrate.

In accordance with a fifth aspect of the invention there is provided a security device formed in accordance with the method of either the third or fourth aspects of the invention.

In accordance with a sixth aspect of the invention there is provided a security article comprising a security device according to any of the first, second of fifth aspects, wherein the security article is preferably a security thread, strip, foil, insert, transfer element, label, patch, or a data page for a security document.

In accordance with a seventh aspect of the invention there is provided a security document comprising a security device according to any of the first, second or fifth aspects, or a security article according to the sixth aspect, wherein the security document is preferably a banknote, cheque, passport, identity card, driver's licence, certificate of authenticity, fiscal stamp or other document for securing value or personal identity.

The security device of either the first or second aspect, or manufactured in accordance with the third or fourth aspect, is typically formed as an integrated device—that is the decorative layer, array of viewing elements and masking layer are formed as a unitary device. However, it is envisaged that in security devices according to the invention, the decorative layer may be provided separately to the array of viewing elements and the masking layer. Thus, in accordance with an eighth aspect of the invention, there is provided a security arrangement comprising: a security document (or security article) that comprises a masking layer and an array of viewing elements; and a decorative layer; wherein the decorative layer may be arranged with the masking layer and array of viewing elements to form a security device according to either the first or second aspects, or made in accordance with either the third or fourth aspects. The masking layer, array of viewing elements and decorative layer are as described with respect to any of the aspects of the invention above such that the formed security device exhibits the described visual effects in different lighting conditions.

The decorative layer may be provided separately to the security document. For example, the security document may be a bank note, with the decorative layer provided on a separate banknote or separate article. In other embodiments, the decorative layer is provided on said security document and (e.g. laterally) spaced from the masking layer and array of viewing elements, preferably such that the security document may be folded so as to form a security device according to either the first or second aspects or made in accordance with the thirds or fourth aspects.

### BRIEF DESCRIPTION OF THE DRAWINGS

Preferred examples of the present invention will now be described with reference to the attached drawings, in which:—

FIG. 1(a) is a cross-sectional view of a security device according to an example embodiment of the invention, and FIGS. 1(b) to 1(d) illustrate the appearance of the device under different illumination conditions;

FIG. 2(a) is a cross-sectional view of a security device according to a further example embodiment of the invention, and FIGS. 2(b) and 2(c) illustrate the appearance of the device under different illumination conditions;

FIG. 3(a) is a cross-sectional view of a security device according to a further example embodiment of the invention, and FIGS. 3(b) and 3(c) illustrate the appearance of the device under different illumination conditions;

FIGS. 4(a) and 4(b) illustrate the appearance of a security device according to a further embodiment of the invention under different illumination conditions;

FIG. 5(a) schematically depicts a security device in accordance with a further embodiment of the invention, FIG. 5(b) showing a cross-section through the device, and FIGS. 5(c) and 5(d) illustrating the optically variable appearance of the device;

FIG. 6(a) is a cross-sectional view of a security device according to a further example embodiment of the invention, and FIGS. 6(b) and 6(c) illustrate the appearance of the device under different illumination conditions;

FIG. 7 illustrates the appearance of a security device according to a further embodiment of the invention;

FIG. 8(a) is a cross-sectional view of a security device according to a further example embodiment of the invention, and FIGS. 8(b) and 8(c) illustrate the appearance of the device under different illumination conditions;

FIGS. 9(a) and 9(b) illustrate the appearance of a security device according to a further embodiment of the invention under different illumination conditions;

FIGS. 10(a) to 10(c) illustrate the configuration of the masking layer and decorative layer in accordance with an embodiment of the invention;

FIG. 11(a) is a cross-sectional view of a the security device of FIG. 10, and FIGS. 11(b) and 11(c) illustrate the appearance of the device under different illumination conditions;

FIGS. 12(a) to 12(c) illustrate the configuration of the masking layer and decorative layer in accordance with an embodiment of the invention;

FIGS. 13(a) and 13(b) illustrate the appearance of a security device of FIG. 12 in different illumination conditions;

FIG. 14(a) illustrates the arrangement of the masking layer of a security device according to an embodiment of the invention, and FIG. 14(b) depicts the visual appearance of the security device;

FIG. 15(a) illustrates the arrangement of the masking layer of a security device according to a further embodiment of the invention, and FIG. 15(b) depicts the visual appearance of the security device;

FIG. 16(a) is a cross-sectional view of a security device according to a further embodiment of the invention, and illustrates the visual appearance of the device at different viewing angles, and FIG. 16(b) illustrates an example viewing element that may be used in the invention;

FIG. 17 is a flow diagram outlining the steps of an exemplary method for forming a security device;

FIGS. 18, 19 and 20 show three exemplary security documents carrying security devices in accordance with embodiments of the invention (a) in plan view and (b) in cross-section;

FIG. 21 illustrates a further exemplary security document carrying a security device in accordance with embodiments of the present invention (a) in front view, (b) in back view and (c) in cross-section; and

FIG. 22 illustrates a further example of a security document carrying a security device in accordance with the invention.

### DETAILED DESCRIPTION

The following description sets out a number of embodiments of different security devices, and methods of manufacture thereof, according to the invention. However, it will be appreciated that the visual appearances of the devices in the examples are exemplary only, and different configurations of the viewing elements and pattern elements are envisaged so as to present different visual appearances, for example different indicia. The attached figures use different shading patterns to indicate different colours.

For ease of description, in the following examples the scenario where the security device is illuminated in the absence of the at least one excitation wavelength will be referred to as illumination under visible light, and the scenario where the security device is illuminated by the at least one excitation wavelength will be referred to as illumination under UV light. As discussed above, in this specification UV wavelengths refer to wavelengths between 200 nm and 400 nm, preferably between 235 nm and 380 nm. It should also be understood that when viewing under UV light there will also be visible light present so that colours visible under visible light illumination conditions will also contribute to the overall appearance in UV light.

The security device of the present invention is intended to be viewed primarily in reflected light from the side of the viewing elements. However, the device may be viewed from the side of the lenses in transmitted light if light is able to pass through the decorative layer.

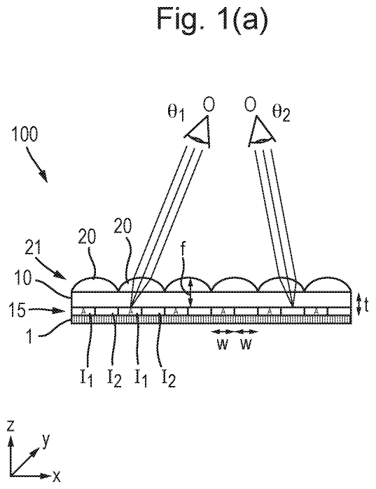

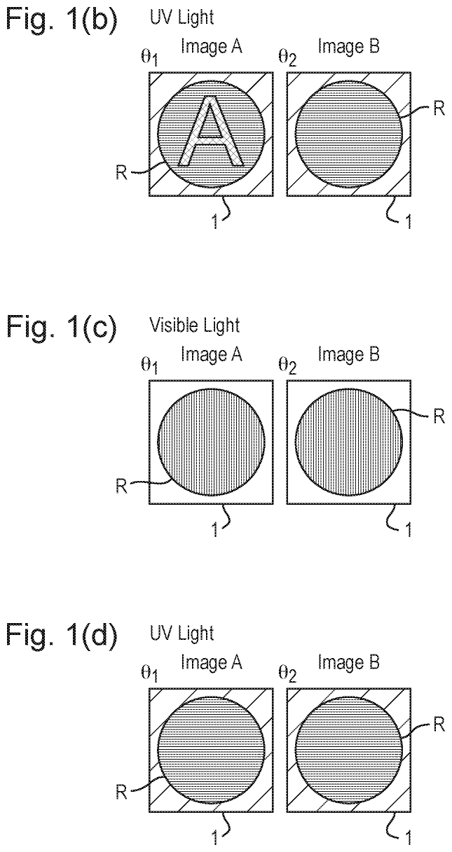

FIG. 1(a) illustrates a cross-sectional view of a security device 100 according to a first example embodiment of the invention. In this example, the security device is a lenticular device. A substantially transparent substrate 10 is provided on one surface with an array 21 of focusing elements 20, here in the form of cylindrical lenses, and on the other, opposing, surface with a masking layer in the form of an array 15 of pattern elements, and a decorative layer 1. The masking layer is positioned between the decorative layer and the focussing elements. The pattern element array 15 comprises an arrangement of first pattern elements and second pattern elements. In this embodiment and the following example embodiments the first pattern elements are formed of a UV absorbing ink, and the second pattern elements are defined by the absence of said UV absorbing ink. The UV absorbing ink absorbs all wavelengths within the UV part of the electromagnetic spectrum such that when the device is illuminated under UV light, the first pattern elements appear black.

In this example the pattern of first and second pattern elements defines sections of two images interleaved with each other along a first direction, which in this case is along the x-axis. The image sections I₁, I₂ and their interleaved nature is illustrated in FIG. 1(a). The direction of interleaving is substantially perpendicular to the axial direction of the cylindrical lenses 20, which here is along the y-axis.

The lenses 20 have a focal length f that is substantially equal to the optical spacing between the lenses and the decorative layer 1, such that the focal plane of the array of lenses substantially corresponds to the plane of the pattern element array 15. In other words, the combined thickness of the lenses themselves and the transparent substrate 10 (the thickness of which is illustrated by t) is substantially equal to the focal length f of the lenses 20. Focussing elements that may be used in the present invention typically have a pitch in the range of 5-100 microns, preferably 20-60 microns; a height of 5-40 microns, preferably 5-20 microns and a focal length of 5-100 microns, preferably 5-75 microns. Typical thicknesses, t, of the transparent substrate are in the range of 9-150 microns, preferably 12-100 microns.

As best shown in the cross-section of FIG. 1(a), the pattern element array 15 and the focusing element array 21 have substantially the same periodicity as one another in the x-axis direction, such that one first image section I₁ and one second image section I₂ lies under each lens 20. In this case, as is preferred, the width, w, of each image section I₁, I₂ is approximately half that of the lens pitch. In this example, the image array is registered to the lens array 20 in the x-axis direction (i.e. in the arrays' direction of periodicity) such that a first image section I₁ lies under the left half of each lens and a second image section I₂ lies under the right half. However, registration between the lens array 20 and the image array in the periodic dimension is not essential.

The decorative layer 1 comprises a luminescent material. In the following example embodiments the decorative layer comprises an ink arranged in first region R, the ink comprising the luminescent material. For the purposes of this specification an ink is a composition comprising a binder carrying appropriate luminescent materials together with any dyes and/or pigments as necessary to exhibit the desired colour effects, of which examples will be given below. The ink used to form the decorative layer may be referred to herein as a “luminescent ink”.

The first region R may extend across the whole pattern element array 15, and even across the whole device, or may extend over a part (or “zone”) of the pattern element array, in which case within that zone the second pattern elements will possess the optical characteristics of the first region whereas outside that zone the second pattern elements may be transparent or may take on the colour of some underlying backing layer or substrate. In general the first region covers at least some first pattern elements and some second pattern elements such that under UV illumination the device exhibits an optically variable effect due to the perceived contrast between the first and second pattern elements where the first region R overlaps with the array. In this example the first region R overlaps with each first pattern element.

In this example the first region R is in the form of a circle when the device is viewed in plan view. Here, the luminescent ink exhibits a non-luminescent blue colour (i.e. appears blue) when illuminated by visible light, and exhibits a luminescent yellow colour (i.e. appears yellow) when illuminated under UV light.

The image sections of the pattern element array overlap with the region, R defined by the luminescent ink of the decorative layer 1. In contrast to the dimensions of the pattern elements and image sections, the dimensions of the region R are significantly larger than the pitch of the lenses 20 of the lens array such that the region R substantially does not interact with the lenses to provide an optically variable effect.

As we have seen above, the UV absorbing ink appears black when the device is illuminated by UV light. The UV absorbing ink is also substantially transparent and substantially colourless when illuminated by visible light. The consequences of these properties of the UV absorbing ink, and the configuration of the pattern element array and the luminescent ink will now be explained.

When the device 100 is viewed by an observer O from a first viewing angle θ₁ within the x-z plane, each lens 20 will direct light from its underlying first image section I₁ to the observer. When the device is tilted so that it is viewed by a second observer O₂ at a second viewing angle θ₂ within that viewing plane, now each lens 20 directs light from the second image sections I₂ to the observer. In other words, at viewing angle θ₁, the observer sees the first image sections in combination, and viewing angle θ₂ the observer sees the second image sections in combination.

When the device 100 is illuminated with visible light and viewed in reflection from the side of the lenses, at viewing angle θ₁ the observer perceives a blue circle against a white background (see FIG. 1(c)). This is because under visible light, the UV absorbing ink is substantially transparent and substantially colourless, and therefore the luminescent ink is visible through the first pattern elements. The part of the device outside of the region R is substantially transparent, represented by the white background in FIG. 1(c), At viewing angle θ₂, the observer perceives the same image (i.e. a blue circle) as the luminescent ink is visible through the second pattern elements. Consequently, when the security device 100 is viewed in reflection under visible light and from the side of the lenses, as the device is tilted, the observer will perceive substantially no change in the exhibited image. In other words, no optically variable effect is exhibited.

However, when the device 100 is illuminated by UV light and again viewed in reflection from the side of the lenses 20, at viewing angle θ₁ the image perceived by the observer comprises a black letter “A” against a circular yellow background, whereas at viewing angle θ₂ the image perceived by the observer comprises a yellow circle in isolation with no “A” present, as illustrated in FIG. 1(b). This is because the image sections I₁ together comprise an arrangement of first pattern elements and second pattern elements that together define the letter “A”. In this case, the background to the “A” is defined by second pattern elements with the luminescent ink of region R viewable therethrough.

In contrast, the second image sections I₂ are formed entirely of second pattern elements (i.e. they do not comprise any UV absorbing ink) such that at viewing angle θ₂, the device 100 exhibits the appearance of the luminescent ink, i.e. a yellow circle as seen in FIG. 1(b). Hence, as the security device is tilted back and forth between viewing angles θ₁ and θ₂ under UV illumination, the appearance of the device switches between image A and image B as shown in FIG. 1(b).

Under UV light illumination, the part of the device outside of the first region R of the decorative layer 1 appears brown/black as this part of the device does not luminesce in response to UV irradiation.

Therefore, on a change of illumination conditions from visible light to UV light, not only does the appearance of the security device 100 change, but so does the information content conveyed to the observer, as the appearance of the device alters by more than just a change in colour. Here, under visible light, there is substantially no optically variable effect whereas under UV illumination, there is an optically variable effect exhibited upon tilting the device, as illustrated in FIG. 1(b).

This change in information content (on top of different colours exhibited) under visible and UV lighting conditions provides a memorable and easily authenticatable visual effect which is difficult to counterfeit.

It is to be noted that when the device 100 is viewed from the side of the decorative layer 1 under visible light, the viewer would see the images as shown in FIG. 1(c) due to the coloured nature of the luminescent ink under visible light. Under UV light, the viewer would perceive a yellow circle corresponding to the region, R, of the luminescent ink at both viewing angles θ₁ and θ₂, as illustrated in FIG. 1(d). In contrast to the situation when the device is viewed from the side of the lenses, although there is a change in colour when moving from one lighting condition to the other, there is no change in information content in the manner as discussed above as there is no introduction of an optically variable effect.

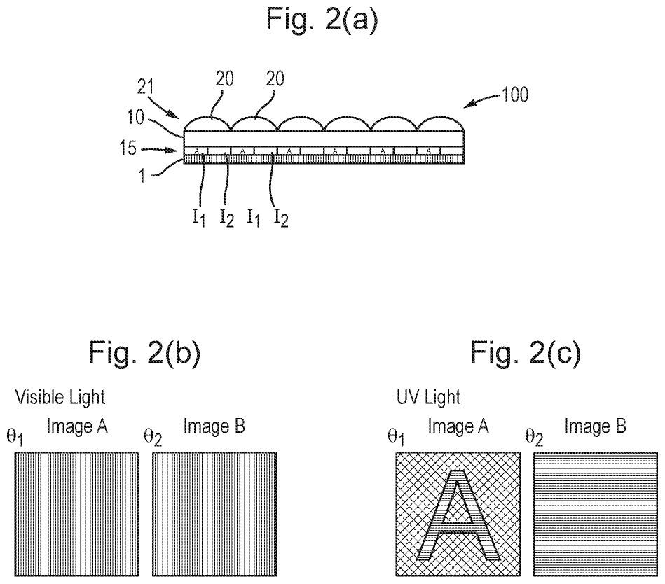

FIG. 2 illustrates a further example embodiment similar to the one discussed above in relation to FIG. 1. In this example, the luminescent ink of the decorative layer 1 extends substantially completely across the (square) device. Again, the UV absorbing ink is substantially transparent and clear in visible light such that the images exhibited at viewing angles θ₁ and θ₂ in visible light are optically invariable blue squares as represented in FIG. 2(b).

In a similar manner to the embodiment of FIG. 1, the first pattern elements and second pattern elements are arranged in accordance with interleaved image sections I₁, I₂. The image sections I₂ are made up of second pattern elements (i.e. do not comprise any UV absorbing ink) and therefore when the device is viewed under UV illumination, the image exhibited at viewing angle θ₂ is a uniform yellow square as the luminescent ink is visible through the second pattern elements of the second image sections. The first image sections comprise both first pattern elements and second pattern elements, with the first pattern elements defining a background of a letter “A”. Therefore, under UV light and when viewed in reflection from the side of the lenses 20, at viewing angle θ₁ the device exhibits a yellow letter “A” against a black background. The two images of the optically variable effect exhibited under UV light are illustrated in FIG. 2(c).

The devices of FIGS. 1 and 2 exhibiting such an “image reveal” optically variable effect under UV illumination proves a memorable and easily authenticatable optical effect, which is difficult to counterfeit.

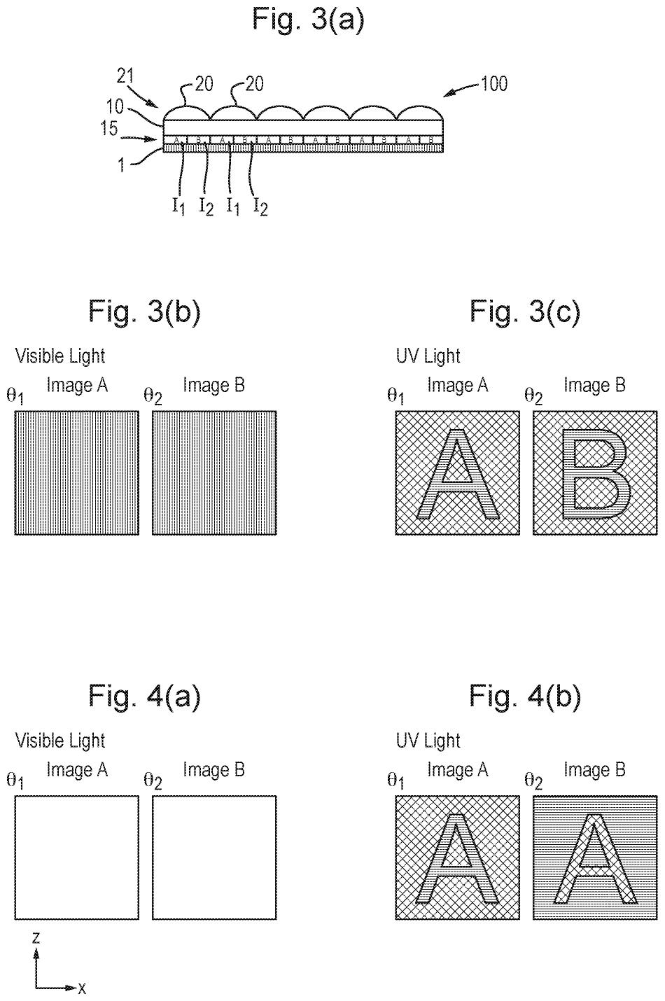

In the example embodiments of FIGS. 1 and 2, the optically variable effect exhibited by the device under UV light was made up of a first image exhibiting a text character “A” against a background, and a second image of a single uniform colour. FIG. 3 shows a further embodiment where the optically variable effect in UV light exhibits different indicia at different viewing angles θ₁ and θ₂. This is achieved because the second image sections I₂ do not correspond exclusively to second pattern elements. Therefore, both image sections I₁ and I₂ comprise first pattern elements and second pattern elements, as schematically shown in the cross-sectional view of the device in FIG. 3(a), with the first image sections labelled as “A” and the second image sections I₂ labelled as “B”. In the example of FIG. 3, in the first image sections the first pattern elements define a background of a letter “A”, and in the second image sections the first pattern elements define the background of a letter “B”. Therefore, as above, when the device 100 is viewed under visible light an observer perceives an optically invariable (“static”) optical effect with the device exhibiting a blue colour at substantially all viewing angles (FIG. 3(b)). However, under illumination by UV light, at viewing angle θ₁ the device exhibits a yellow “A” against a black background, and at viewing angle θ₂ the device exhibits a yellow “B” against a black background, as represented in FIG. 3(c).

It will be understood that more than two images can be interleaved in this way in order to achieve a wide range of animation, morphing, zooming effects etc.

FIG. 4 shows a further example embodiment of the invention in which not only is the UV absorbing ink of the masking layer substantially transparent and substantially colourless under visible light, but in addition the luminescent ink of the decorative layer is also substantially colourless under visible light as well. Therefore, when viewed under visible light, the device 100 appears substantially colourless at substantially all viewing angles, as illustrated in FIG. 4(a). This advantageously means that the optically variable effect exhibited under UV illumination may be particularly unexpected after general viewing in visible light, providing a high level of security.

In the example of FIG. 4, the first and second pattern elements define sections of first and second images interleaved with each other periodically along the x axis. The set of first image sections comprises both first pattern elements and second pattern elements, with the second pattern elements defining a letter “A” against a background of first pattern elements. Similarly, the set of second image sections comprises both first pattern elements and second pattern elements, this time with the first pattern elements defining a letter “A” against a background of second pattern elements. This provides a striking “phase shift” optically variable effect when the device is viewed under UV light, with a yellow letter “A” visible against a black background at first viewing angle θ₁ when the first image sections are visible, and a black letter “A” against a yellow background at second viewing angle θ₂ when the second image sections are visible.

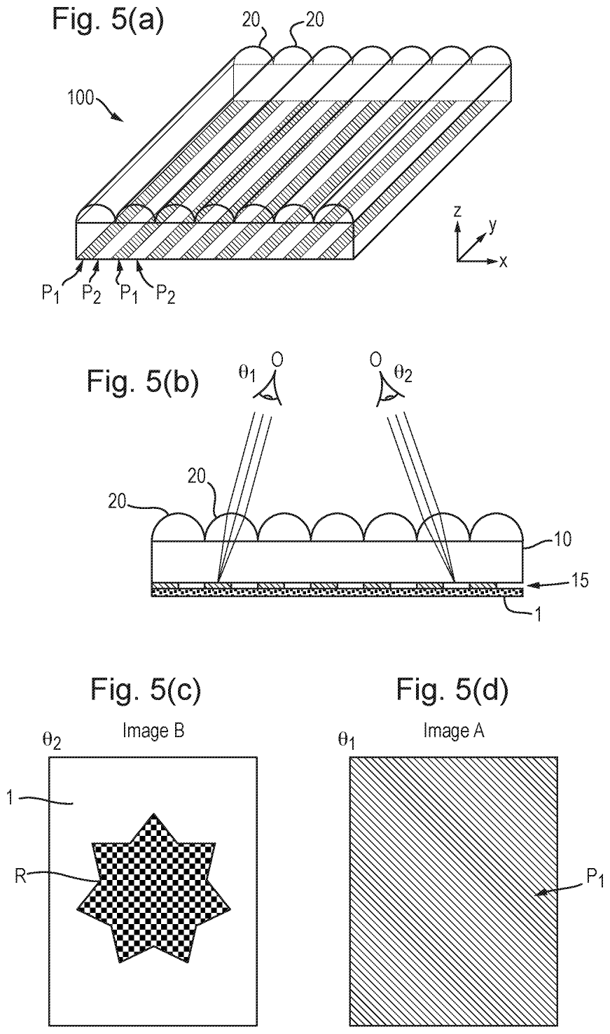

We will now discuss examples where the array of pattern elements is arranged in the form of a “parallax barrier” (or “venetian blind”), which provides an optically variable effect when the device is illuminated under UV light. This concept is now discussed with reference to FIG. 5. Here, the array of pattern elements 15 comprises first pattern elements P₁, and second pattern elements P₂. The first pattern elements P₁ are formed of UV absorbing ink, and the second pattern elements are defined by an absence of the UV absorbing ink. In other words, the second pattern elements may be seen as the “gaps” between adjacent first pattern elements.

The size and shape of each of the first pattern elements P₁ is substantially identical. The pattern elements in this example are elongate strips and so the overall pattern of the elements is a line pattern, with the elongate direction of the lines lying substantially parallel to the axial direction of the focusing elements 20, which here is along the Y axis.

The array of pattern elements is registered to the array of lenses 20 in the x-axis direction (i.e. in the arrays' direction of periodicity) such that a first pattern element P₁ lies under the left half of each lens 20, and a second pattern element P₂ lies under the right half.

As is clearly shown in FIG. 5(b), when an observer views the device 100 at a viewing angle θ₁, each lens 20 will direct light from its underlying first pattern element P₁ to the observer. Conversely, when the device is tilted so that it is viewed by an observer at a second viewing angle θ₂, now each lens 20 directs light from the second pattern elements P₂ to the observer. As the second pattern elements P₂ are defined by the absence of UV absorbing ink, at viewing angle θ₂, the decorative layer 1 is visible within the second pattern elements P₂.

Thus, under UV illumination, at viewing angle θ₁, the device exhibits an image that is a uniform black colour, as illustrated in FIG. 5(d). Under UV illumination and viewing at viewing angle θ₂, the device exhibits an image defined by the appearance of the decorative layer 1, and more specifically the region, R, of the luminescent ink, as seen in FIG. 5(c). Hence, as the security device is tilted back and forth between viewing angles θ₁ and θ₂, the appearance of the device switched between image A and image B.

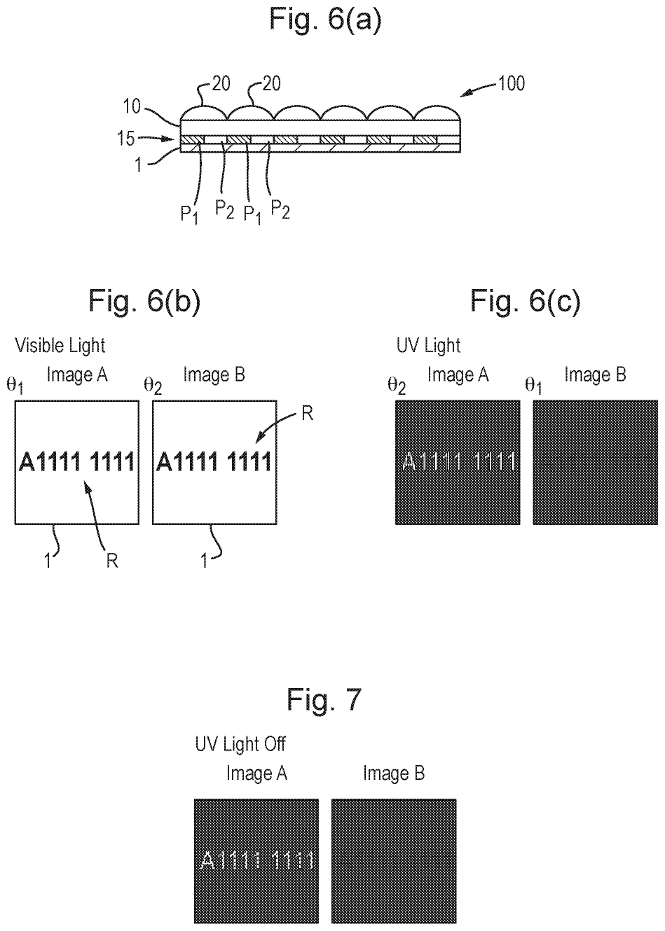

An example of this is seen in FIG. 6, where the array 15 of pattern elements is arranged as seen in FIG. 5(a), (schematically illustrated in the cross-section of FIG. 6(a)), and the luminescent ink is arranged in a first region corresponding to a serial number, here “A1111 1111”. In this example, the luminescent ink exhibits a non-luminescent black colour under visible light illumination, and luminesces to exhibit a blue colour under UV light.

Under illumination with visible light, due to the UV absorbing material being transparent and colourless under these illumination conditions, the appearance of the device at both viewing angles θ₁ and θ₂ is substantially the same, with the serial number being visible at substantially all viewing angles as illustrated in FIG. 6(b), However, under UV illumination, at viewing angle θ₁, light from the first pattern elements P₁ is directed to the observer and as such the serial number formed by the luminescent ink is not visible. However, at viewing angle θ₂, the luminescent material is visible within the second pattern elements P₂, and therefore the serial number is exhibited.

The luminescent ink may comprise a phosphorescent material that continues to luminesce after illumination with the UV radiation has stopped (in contrast to fluorescent materials where the luminescent effect stops substantially immediately on removal of the at least one excitation wavelength). Thus, with the UV light removed and the device 100 viewed in visible light, the serial number is visible in a green colour at viewing angle θ₂, as illustrated in FIG. 7.

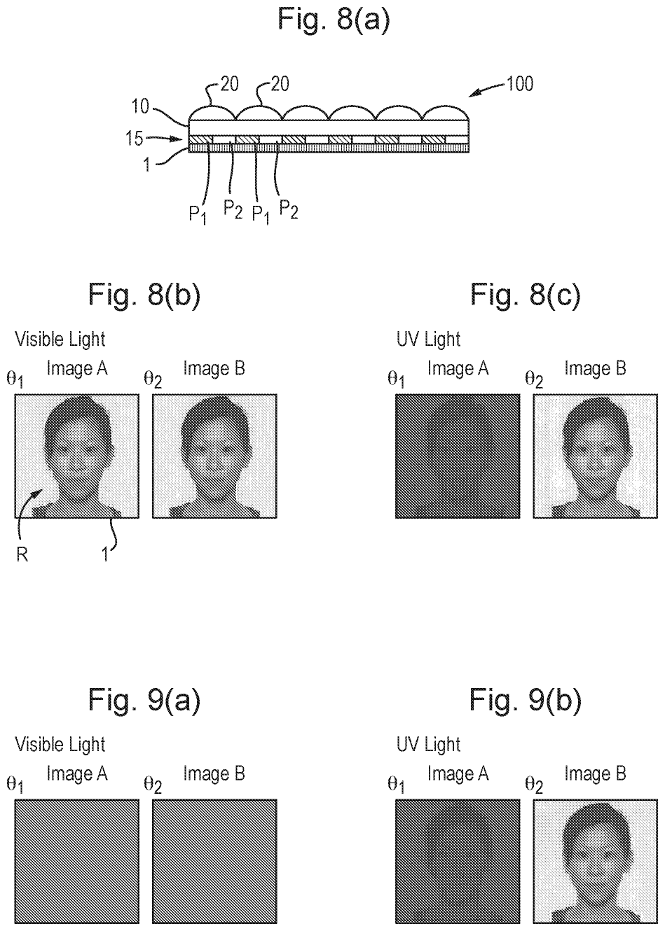

FIG. 8 illustrates an example embodiment where the luminescent ink of the decorative layer exhibits a complex multi-coloured photograph under both visible and UV light. As will be appreciated by the skilled person, in order to form a multi-coloured photograph the decorative layer therefore typically comprises a plurality of luminescent inks, e.g. four inks that exhibit CMYK colour mixing in visible light and corresponding colour mixing in UV light. Other colour mixing models such as RGB may be used. As with the previous examples, the UV absorbing ink of the first pattern elements is substantially transparent and substantially colourless under visible light illumination, and is in the form of a “parallax barrier” line pattern as represented by the cross-section in FIG. 8(a).

Therefore, when the device 100 is illuminated by visible light and viewed in reflection from the side of the lenses 20, an observer perceives the same colour photograph at both viewing angles θ₁ and θ₂, as represented by FIG. 8(b). However, upon illumination with UV radiation and viewing at viewing angle θ₁, the pattern elements P₁ mask the luminescent ink, thus obscuring the image. Conversely, at viewing angle θ₂ under UV illumination, the colour photograph is visible within the second pattern elements P₂. This optically variable effect under UV light is illustrated in FIG. 8(c).

It is to be noted that although the decorative layer and/or array of pattern elements may define an “image”, the overall appearance of the security device under a stated illumination condition is also referred to as an “image”.

FIG. 9 illustrates a variation on the embodiment described above with reference to FIG. 8. The arrangement of pattern elements is the same as that outlined above in the FIG. 8 embodiment; however, the decorative layer comprises inks that combine to exhibit a multi-coloured colour photograph under UV illumination, with each ink containing a pigment that exhibits a uniform red colour under visible lighting conditions. In the same way as described in the above embodiments, under visible light conditions the device exhibits a “static” optical effect that is substantially independent of viewing angle (here a uniform red square as shown in FIG. 9(a)). In contrast, under UV illumination, the device 100 exhibits substantially the same optically variable effect as in FIG. 9, and is represented in FIG. 9(b). As discussed above, this change in information content conveyed to the observer when switching from visible to UV illumination of the device provides a memorable effect to the observer which is easy to authenticate and yet highly difficult to counterfeit.

In the examples provided so far, the UV absorbing ink of the first pattern elements has been substantially transparent and substantially colourless under visible light. This has meant that when illuminated under visible light, the first pattern elements and second pattern elements have had substantially the same visual appearance such that there is no optically variable effect exhibited by the device. We now move on to look at examples where the device exhibits an optically variable effect under both visible light and UV illumination.

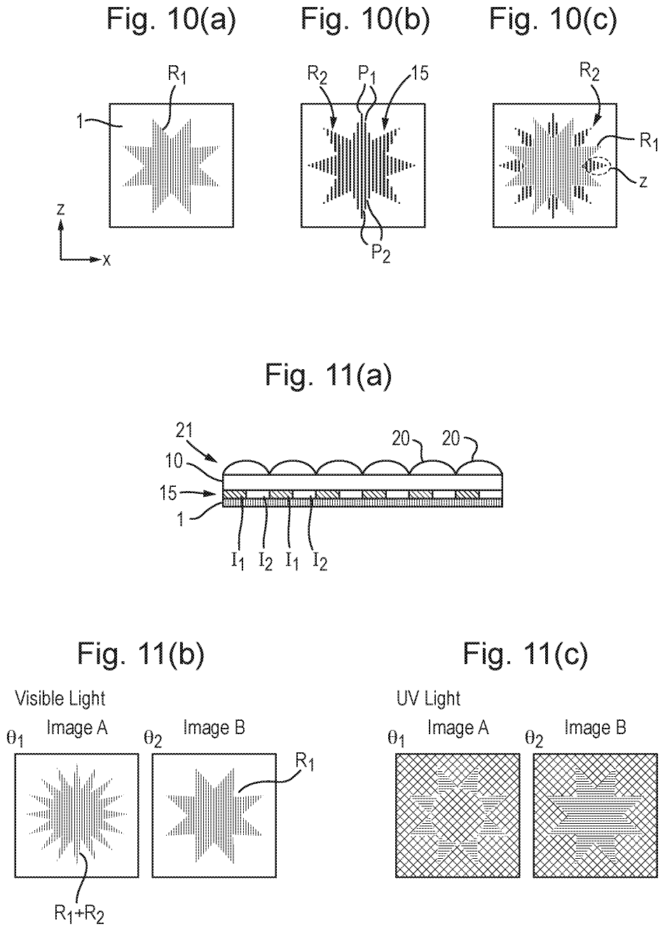

FIG. 10 illustrates an example embodiment of the invention where, under visible fight illumination, the UV absorbing material exhibits a non-luminescent visible colour (here, blue). The luminescent ink of the decorative layer 1 defines a first region R₁, here in the shape of an 8-pointed star, as shown in FIG. 10(a). The luminescent ink of this exemplary embodiment comprises pigments that exhibit a blue non-luminescent colour in visible light and a luminescent material that exhibits a yellow luminescent colour in response to illumination by UV radiation.

FIG. 10(b) illustrates the arrangement of the pattern element array 15 comprising first pattern elements P₁ and second pattern elements P₂. In the same manner as described above in the embodiments of FIGS. 1 to 5, the pattern of first and second pattern elements define sections I₁, I₂ of two images interleaved with each other along a first direction, which in this case is along the x-axis. The first image is that of an 8-pointed star, having a periphery that defines a second region R₂. The second image is of uniform appearance (i.e. the second image sections are made up exclusively of second pattern elements).

Here, parts (labelled Z) of the second region R₂ defined by the pattern element array 15 extend beyond the periphery of the first region R₁ defined by the luminescent ink of the decorative layer, as seen in FIG. 10(c). The resulting device is schematically shown in cross section in FIG. 11(a).

Under illumination by visible light, in the areas Z, the first pattern elements P₁ and the second pattern elements P₂ have a different visual appearance. As such, the device exhibits an optically variable effect in visible light, which is schematically shown in FIG. 11(b). More specifically, at viewing angle θ₁, the first pattern elements P₁ are visible such that the image perceived by the observer is a 16-pointed star that is a superposition of the regions R₁ and R₂. Thus the regions R₁ and R₂ may be said to complement each other, with the region R₂ defined by the array of pattern elements in isolation being at least partially discernible at viewing angle θ₁.

In contrast, upon tilting the device and viewing at viewing angle θ₂ under visible light, only the second pattern elements P₂ of the areas Z are visible. As there is no luminescent ink visible through the second pattern elements in the areas Z, at viewing angle θ₂ the device exhibits the star shape defined of region R₁ defined by the luminescent ink.

Under illumination by UV light, at viewing angle θ₁, the device exhibits an image comprising the outer points of the star shape defined by region R₁ in yellow, as these portions of the luminescent material are not covered by UV absorber material. At viewing angle θ₂, the star shape defined by the luminescent ink is visible in a yellow colour. This is schematically shown in FIG. 11(c).

Thus, the embodiment described above with reference to FIGS. 10 and 11 exhibits an optically variable effect in both visible and UV light conditions. The optically variable effect under visible light differs from the optically variable effect under UV light not only in the colour of the luminescent ink but also in the change of the image shapes exhibited on varying the viewing angle. As such, the information conveyed to the observer under visible light is different to the information conveyed under UV light. This combination of an optically variable effect being exhibited under two different lighting conditions, together with a change in conveyed information content, provides a device that is highly secure against counterfeiting.

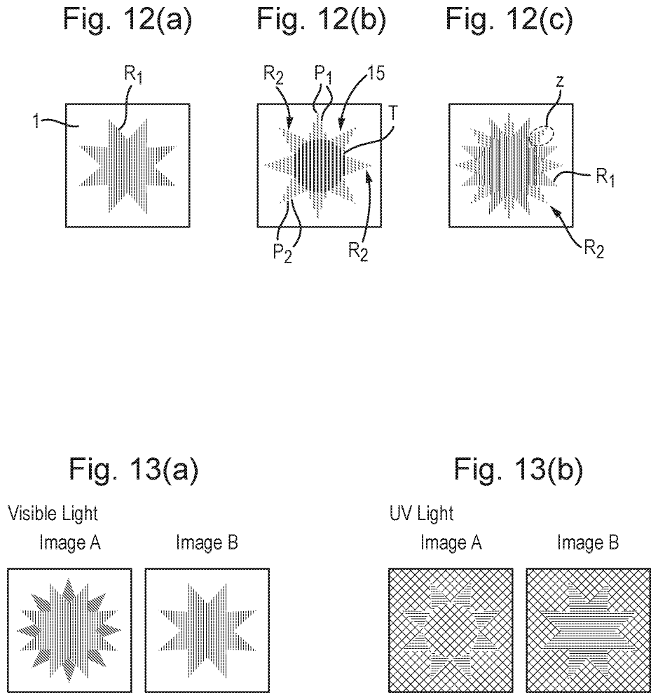

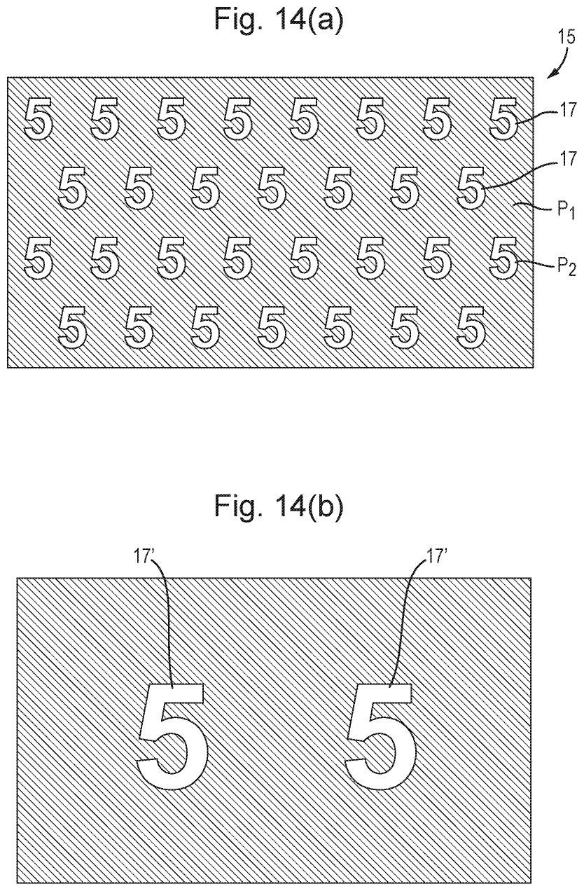

FIGS. 12 and 13 illustrate a further variation on the previous embodiment, where in this example the UV absorbing ink exhibits a different visible colour under visible illumination to that of the luminescent ink of the decorative layer, and also comprises a transparent region, giving rise to further complex effects.

The first and second regions R₁, R₂ defined by the luminescent ink and the pattern element array respectively are the same 8-pointed stars as seen in the previous embodiment, and are shown in FIGS. 12(a) and 12(b). However, here, the second region R₂ comprises a sub-region (the points of the star) that exhibits a red colour in visible light, and a further sub-region (the interior of the star) that is substantially transparent and colourless in visible light. Hence, some first pattern elements P₁ comprise a portion formed of a first UV absorbing ink that exhibits a red colour in visible fight and a portion formed of a second UV absorbing ink that is substantially transparent and colourless in visible light. The transparent sub-region of the pattern element array is illustrated at T in FIG. 12(b).

The overlaid appearance of the pattern element array 15 on the luminescent ink of the decorative layer is illustrated in FIG. 12(c).

Under visible light, at viewing angle θ, a multi-coloured 16-pointed star is visible, corresponding to the outer peripheries of regions R₁ and R₂, and at viewing angle θ₂, the star shape defined by the luminescent material (i.e. region R₁) is visible, as illustrated in FIG. 12(a). Under UV light, the same optically variable effect as discussed above in the previous embodiment is exhibited, which is illustrated in FIG. 13(b).

In a further variation on the embodiment of FIGS. 12 and 13, the pattern element array 15 may comprise first pattern elements formed of a UV absorbing ink that exhibits a non-luminescent colour in visible light that differs from the non-luminescent colour of the luminescent ink, with the region R₂ laterally completely contained within region R₁. This would still provide an optically variable effect in visible light due to the visual (i.e. colour) difference between the first and second pattern elements.

The exemplary embodiments described thus far have been directed to lenticular devices. An embodiment of the invention will now be described with reference to FIG. 14, where the security device is a moiré magnifier, comprising a pattern element array 15 that defines an array of microimages 17 and an overlapping focussing element array (here, spherical lenses) with a pitch or rotational mismatch necessary in order to achieve the moiré effect. FIG. 14(a) depicts the pattern element array 15 as it would appear without the overlapping lens array, i.e. the non-magnified microimage array, but shown at increased scale for clarity.

In this example, the second pattern elements P₂ form a regular array of microimages which here each convey the digit “5”. In this case, all of the microimages are of identical shape and size, although in other embodiments the microimages may vary in shape and/or size. The first pattern elements P₁ comprising the UV absorbing ink form a contiguous, uniform background surrounding the microimages 17. The luminescent ink of the decorative layer 1 extends laterally across the whole of the pattern element array, and is visible through the second pattern elements of the pattern element array.

The luminescent ink of the decorative layer 1 exhibits a blue non-luminescent colour in visible light and a yellow luminescent colour under UV illumination. Under visible light the UV absorbing material is substantially transparent and colourless. Thus, when the device is viewed under visible light, the device appears a substantially uniform blue colour with no optically variable effect exhibited as both the first and second pattern elements have the same visual appearance. Conversely, under UV illumination, the viewer perceives an optically variable effect with the moiré effect acting to magnify the microimages 17 defined by the second pattern elements P₂. More specifically, the viewer perceives an array of magnified yellow microimages 17′, each in the form of the digit “5”. Upon tilting of the device (i.e. changing the viewing angle), the magnified microimages 17′ appear to move relative to the device.

FIG. 14(b) represents the appearance of the device when viewed under UV illumination, at a first viewing angle approximately normal to the plane of the device. It should be noted that the scale of FIG. 14(b) is the same as that of FIG. 14(a), with the apparent enlargement effect due to the focussing element array and the moiré effect. In this example, just two of the enlarged microimages 17′ are shown. In practice, the size of the enlarged microimages and their orientation relative to the device will depend on the degree of mismatch between the focussing element array and the array of microimages 17.

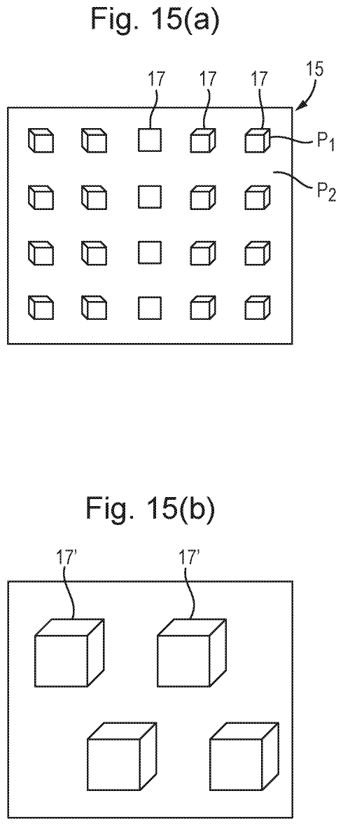

In the example security device of FIG. 14 above, the microimages 17 are all identical to one another, such that the device can be considered a “pure” moiré magnifier. However, the same principles can be applied to “hybrid” moiré magnifier/integral imaging devices, in which the microimages depict an object or scene from different viewpoints. Such microimages are considered substantially identical to one another for the purposes of the present invention. An example of such a device is shown schematically in FIG. 15, where FIG. 15(a) shows the unmagnified pattern element array 15, without the effect of focusing elements 20, and FIG. 15(b) shows the appearance of the finished security device, i.e. the magnified image. As shown in FIG. 15(a), the microimages 17 show an object, here a cube, from different angles. The microimages 17 are formed as first pattern elements P₁ corresponding to the black lines of the cubes in the Figure, with the second pattern elements forming a contiguous uniform background, although the reverse configuration could be used. The region defined by the luminescent ink extends laterally across the whole of the pattern element array so as to cover each of the microimages 17, and is visible through the second pattern elements, so that under UV light the magnified microimages 17′ appear as black lines against the luminescent colour background of the luminescent ink. In the magnified image (FIG. 15(b)), the moiré effect generates magnified, 3D versions of the cube labelled 17′.

Further interesting effects may be generated if the region R defined by the luminescent ink covers only a part of the pattern element array 15 (i.e. covers only some of the microimages), with the microimages overlapping with the first region being more strongly visible under UV illumination. In the optically variable effect visible under UV fight, as the magnified microimages appear to move relative to the device as the device is tilted, the microimages appear to move in and out of the first region, providing an optical effect with high visual impact.

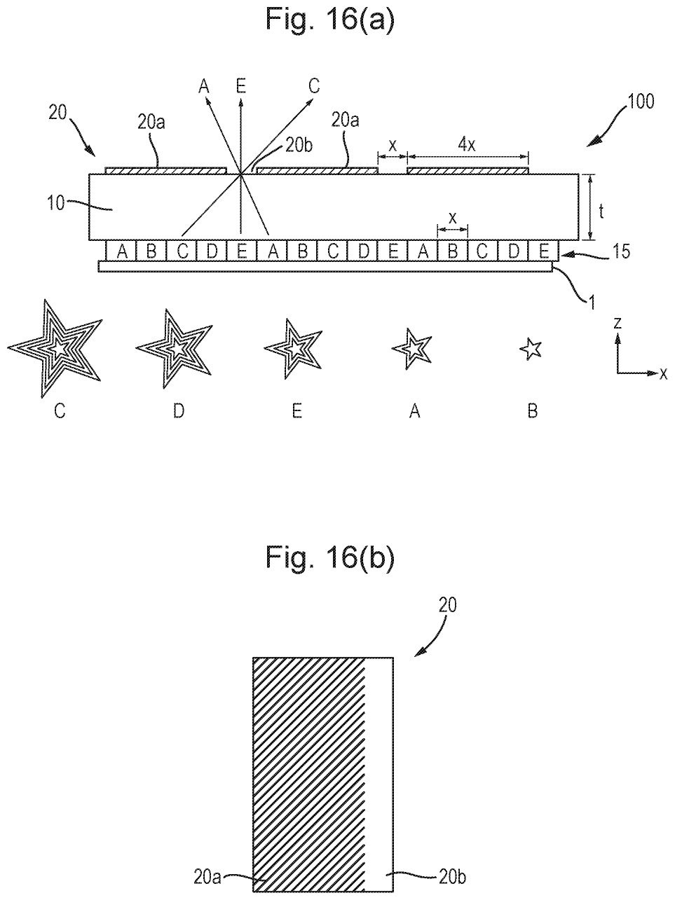

In all of the above examples of security devices, the viewing element employed to cooperate with the pattern element array to generate the optically variable effect(s) is a focussing element array, FIG. 16(a) shows an example security device which exhibits an optically variable effect under at least UV light illumination wherein the viewing elements are not required to be focussing elements such as lenses. In this example, each viewing element 20 comprises a substantially opaque (to at least UV light, and preferably also to visible light) portion 20a, and a gap region 20b. A plan view of such a viewing element 20 is shown in FIG. 16(b). The array of such viewing elements may be referred to as a “masking grid”, and could be composed of an array of metal lines 20a spaced by gaps 20b, for example.

The first and second pattern elements of the pattern element array 15 are arranged as a sequence of interlaced image sections A, B, C, etc., with the direction of interleaving here being along the x-axis. Each of the complete images A, B, C, etc. from which the image sections are taken is shown under the cross-section of the device, and it will be seen that these comprise a sequence of animation steps depicting a star symbol changing in size.

The luminescent ink of the decorative layer 1 substantially completely overlaps with the pattern element array, such that the luminescent ink is visible within the second pattern elements of the pattern element array 15. The luminescent ink exhibits a blue colour in visible light and a yellow luminescent colour when irradiated with UV light. The UV absorbing material of the first pattern elements is substantially transparent and colourless in visible light.

When viewing the device under visible light, no optically variable effect will be perceptible due to the transparent and colourless nature of the UV absorbing material making up the first pattern elements. This means that, under visible light, the first and second pattern elements exhibit substantially the same visual appearance. However, when illuminated with UV light, the device exhibits an optically variable effect, as described below.

Under UV light, when the device 100 is viewed from the side of the viewing elements 20, at any one instant, the image sections from only one of the images A to E are visible. For example, in the configuration shown in FIG. 16(a), when the device is viewed straight-on, only the image sections forming the image E will be visible, and thus the device as a whole will appear to exhibit a complete reproduction of image E. (It is to be noted that dependent on the arrangement of the first and second pattern elements, the images may be exhibited as black lines against a yellow background, or vice-versa.) Provided the dimensions of the device are correctly selected, when the device is observed from different angles, the different images will become visible. For example, when the device is viewed from position A under UV light, only the image sections forming image A will be viewable through the array of viewing elements, or “masking grid”. Similarly, when viewed from position C, image C will be exhibited. As such, as the device is tilted and the observer views it at different viewing angles, different stages of the animation will be seen and, provided that the images of the pattern element array are printed in the correct order, an animation will be perceived—in the present example a star increasing or decreasing in size as the device is tilted. Thus, in this case the animation is perceived as zooming in or out but in other cases the images could be arranged to depict, for example, perceived motion (e.g. a horse galloping), morphing (e.g. a sun changing into a moon) or perceived 3D depth (by providing multiple images of the same object, but from slightly different angles). Of course, fewer images (e.g. two) could be interleaved, resulting in an a “switch” or “reveal” effect at certain angles, as described above in FIGS. 1 to 4 for example, rather than an animation effect.

In order to achieve this effect, the width of each image section, X, must be smaller than the thickness, t, of the transparent substrate 10, preferably several times smaller, such that there is a high aspect ratio of the thickness t to image section width X. This is necessary in order that a sufficient portion of the pattern element array 15 can be revealed through tilting of the device. If the aspect ratio were too low, it would be necessary to tilt the device to very high angles before any change in image will be perceived. In a preferred example, each image section has a width X of the order of 5 to 10 microns, and the thickness t of the substrate 10 is approximately 25 to 35 microns.

The dimensions of the viewing elements 20 are generally larger than those of the pattern elements, requiring opaque stripes 20a of width ((n−1)X) where n is the number of images to be revealed (here, five), spaced by transparent regions 20b of approximately the same width as that of the image sections (X). Thus, in this example the opaque regions 20a of the viewing elements have a width of around 20 to 40 microns and may be produced using conventional techniques such as printing.

Viewing elements in the form of such a “masking grid” may also be used to form devices that exhibit moiré interference patterns. In such devices each of the array of viewing elements and the pattern element array typically consist of an array of line elements. To exhibit moiré effects, a mismatch between line element arrays required in order to form moiré interference fringes. This mismatch may be provided by a rotation of one of the arrays relative to the other, or by a pitch mismatch, and/or isolated distortions in either of the patterns.

In order to achieve significant perceived motion at relatively small viewing angles, a high aspect ratio of the spacing between the two patterns (typically the thickness of the transparent substrate 10) relative to the spacing of the line elements is required. For example, where the line elements of the pattern element array and the viewing element array have a width and a spacing of 5 microns, a thickness of around 25 microns is suitable. No registration between the pattern element array and viewing element array is required.

In the above embodiments, the non-luminescent colour of the luminescent ink is blue, with the ink appearing yellow under UV illumination. Examples of suitable ink formulae for use in these embodiments is set out below, although some adjustments may be necessary as will be readily understood by a person skilled in the art to achieve desired colours. It will be noted that in these cases the ink composition includes one or more visible (non-luminescent) pigments or dyes in addition to the luminescent material, which will typically be necessary unless the luminescent materials have the desired visible body colour. In these examples, each pigment or dye is supplied in the form of a base ink which also includes a binder (ink vehicle) of conventional composition, although this could be added separately. Also included in this case are additives such as driers, to improve the performance of the ink, which are optional.

Red Ink Luminescing Green

9C3002B Bluish Red Base ink (ex SICPA) 16.8%

9H0011B Transparent White Base ink (ex SICPA) 32.8%

9C5033B Yellowish Green Fluorescent Base ink (ex SICPA) 49.7% Cobalt Driers 0.7%

Red Ink Luminescing Orange

9C3002B Bluish Red Base ink (ex SICPA) 16.8%

9H0011B Transparent White Base ink (ex SICPA) 32.8%

9C1979B Yellow Fluorescent Base ink (ex SICPA) 49.7%

Cobalt Driers 0.7%

The two inks described above are responsive to substantially all UV wavelengths in the range 235 to 380 nm and so both inks will display the desired colour change when illuminated with any one UV wavelength in that range (plus visible light). However this is not essential and in other cases the luminescent ink need only be responsive to one or more UV wavelengths, provided that the UV absorbing ink absorbs that one or more UV wavelengths.

Green Ink Luminescing Red

9C1033B Reddish Yellow Base ink (ex SICPA) 7.0%

9C5000B Green Base ink (ex SICPA) 2.6%

9H0011B Transparent White Base ink (ex SICPA) 39.8%

9C3901B Red Fluorescent Base ink (ex SICPA) 50.0%

Cobalt Driers 0.6%

Green Ink Luminescing Yellow

9C1033B Reddish Yellow Base ink (ex SICPA) 7.0%

9C5000B Green Base ink (ex SICPA) 2.7%

9H0011B Transparent White Base ink (ex SICPA) 69.7%

9C1979B Yellowish Fluorescent Base ink (ex SICPA) 20.0%

Cobalt Driers 0.6%

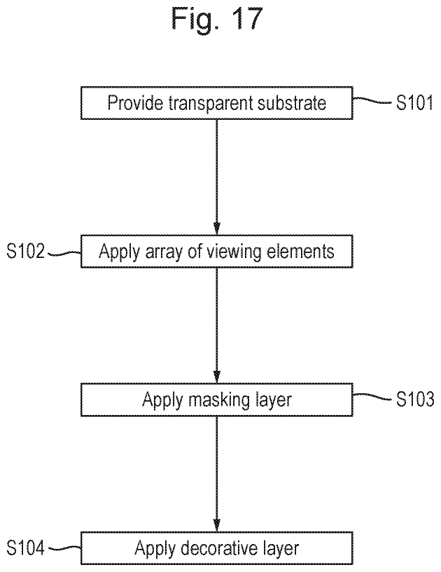

FIG. 17 is a flow diagram illustrating the steps of an example method for manufacturing a security device according to the invention. At step S101 a transparent substrate 10 is provided, typically comprising at least one transparent polymeric material, such as BOPP, PET or polycarbonate, and may be monolithic or multi-layered. The substrate may be of a type suitable for forming the basis of a security article such as a security thread, strip, patch, transfer foil or a data page for a passport, or of a type suitable for forming the basis of a security document itself, such as a polymer banknote. The substrate is typically provided in the form of a substrate web such that a plurality of security devices may be manufactured in a web-based process, although sheet-based processes are also envisaged where the substrate is provided as a plurality of sheets.

At step S102, an array of viewing elements is applied to a first surface of the substrate web (or sheet). Typically the viewing elements are focussing elements such as lenses, which may be formed by, for example, lamination or cast curing. Cast curing involves applying a transparent curable material to a support layer or to a casting tool carrying a surface relief defining the desired focussing element array, forming the material using the casting tool and curing the material to fix the relief structure into the surface of the material. The support layer may be the substrate web, or could be a separate support layer which is later applied to the substrate web (e.g. a transfer foil that may be applied to the substrate web by a foiling machine).

The curable material is cured by exposing it to appropriate curing energy, typically UV radiation from a source. This preferably takes place while the curable material is in contact with the surface relief although if the material is already sufficiently viscous this could be performed after separation of the casting tool from the support layer. The curable material may be irradiated through the support layer (typically the case when the lenses are formed on a transfer foil), although the source could alternatively be positioned above the support layer, e.g. inside the casting tool if it is formed from a suitable transparent material such as quartz.

In one embodiment the curable material is partially cured while in contact with the surface relief, with a subsequent cure performed after the curable material is released from the surface relief to fully cure the curable material. The radiation applied to cure the material after it is released from the surface relief may be directed through the support layer, or from above the support layer.

If the viewing elements formed in step S102 are in the form of a masking grid (as described in relation to FIG. 16) rather than focussing elements, the array of focussing elements may be formed using the techniques described below for forming the pattern element array in step S103.

At step S103 the masking layer is applied to the opposing surface of the web (or sheet) to which the array of viewing elements was applied in step S102. As has been explained above, the masking layer is arranged as an array of pattern elements comprising first pattern elements defined by the presence of masking material (typically UV absorbing ink), and second pattern elements defined by an absence of masking material. The pattern element array may be provided using conventional printing techniques such as lithographic printing, fleoxographic printing, intaglio printing, screen printing or gravure, with line widths typically between 5-50 microns.

At step S104 a decorative layer 1 is applied over the pattern element array formed in step S103. The decorative layer comprises a luminescent material that exhibits a luminescent visible colour in response to irradiation by at least one excitation wavelength (typically within the UV spectrum). The decorative layer typically further comprises a dye and/or pigment that exhibits a non-luminescent colour under visible light illumination. Substances such as these are preferably dispersed in a binder to form an ink, for example, suitable for application by printing or coating, or could be applied by other means such as vapour deposition. Most preferably, the decorative layer is applied by a printing technique such as: laser printing, inkjet printing, lithographic printing, gravure printing, flexographic printing, intaglio printing, screen printing, letterpress or dye diffusion thermal transfer printing.

In the present invention, the high resolution detail of the optically variable effect(s) is provided by the pattern element array, and as such the decorative layer does not need to be applied using a high resolution process. Indeed, the decorative layer preferably has a dimension much larger than that of the viewing elements such that it substantially does not interact with the viewing elements. If desired, the decorative layer may be applied in more than one working (e.g. in order to provide a decorative layer in the form of a complex colour photograph). The decorative layer may also be formed on another substrate and laminated to or transferred to the pattern element array.

As the decorative layer 1 does not need to be applied at high resolution, it can be made relatively thick and may possess sufficiently high optical density to produce a good quality image by itself. However, in some cases, it is desirable to increase the optical density by applying a substantially opaque backing later over the decorative layer.

Although the viewing element array is preferably applied to the substrate web prior to the formation of the masking layer, it may alternatively be applied at any stage during the above manufacturing process, particularly if the viewing elements are in the form of a masking grid which does not require UV curing.

In the embodiments described above, the viewing element array is formed on the opposing surface of the transparent substrate to the masking layer and the decorative layer. However, it is envisaged that in some variations, the decorative layer, masking layer and viewing element layer may be formed on the same surface (i.e. all on the same side of) of the transparent substrate. Such variations would typically require an optical spacer layer between the masking layer and array of viewing element array in order to provide a suitable optical spacing.

Security devices of the sorts described above can be incorporated into or applied to any product for which an authenticity check is desirable. In particular, such devices may be applied to or incorporated into documents of value such as banknotes, passports, driving licences, cheques, identification cards etc. The various components of the security device and/or the complete security device can either be formed directly on the security document (e.g. on a polymer substrate forming the basis of the security document) or may be supplied as part of a security article, such as a security thread or patch, which can then be applied to or incorporated into such a document.

Such security articles can be arranged either wholly on the surface of the base substrate of the security document, as in the case of a stripe or patch, or can be visible only partly on the surface of the document substrate, e.g. in the form of a windowed security thread. Security threads are now present in many of the world's currencies as well as vouchers, passports, travellers' cheques and other documents. In many cases the thread is provided in a partially embedded or windowed fashion where the thread appears to weave in and out of the paper and is visible in windows in one or both surfaces of the base substrate. One method for producing paper with so-called windowed threads can be found in EP-A-0059056. EP-A-0860298 and WO-A-03095188 describe different approaches for the embedding of wider partially exposed threads into a paper substrate. Wide threads, typically having a width of 2 to 6 mm, are particularly useful as the additional exposed thread surface area allows for better use of optically variable devices, such as that presently disclosed.

The security article may be incorporated into a paper or polymer base substrate so that it is viewable from both sides of the finished security substrate at at least one window of the document. Methods of incorporating security elements in such a manner are described in EP-A-1141480 and WO-A-03054297. In the method described in EP-A-1141480, one side of the security element is wholly exposed at one surface of the substrate in which it is partially embedded, and partially exposed in windows at the other surface of the substrate.

Base substrates suitable for making security substrates for security documents may be formed from any conventional materials, including paper and polymer. Techniques are known in the art for forming substantially transparent regions in each of these types of substrate. For example, WO-A-8300659 describes a polymer banknote formed from a transparent substrate comprising an opacifying coating on both sides of the substrate. The opacifying coating is omitted in localised regions on both sides of the substrate to form a transparent region. In this case the transparent substrate can be an integral part of the security device or a separate security device can be applied to the transparent substrate of the document. WO-A-0039391 describes a method of making a transparent region in a paper substrate. Other methods for forming transparent regions in paper substrates are described in EP-A-723501, EP-A-724519, WO-A-03054297 and EP-A-1398174.

The security device may also be applied to one side of a paper substrate, optionally so that portions are located in an aperture formed in the paper substrate. An example of a method of producing such an aperture can be found in WO-A-03054297. An alternative method of incorporating a security element which is visible in apertures in one side of a paper substrate and wholly exposed on the other side of the paper substrate can be found in WO-A-2000/39391.

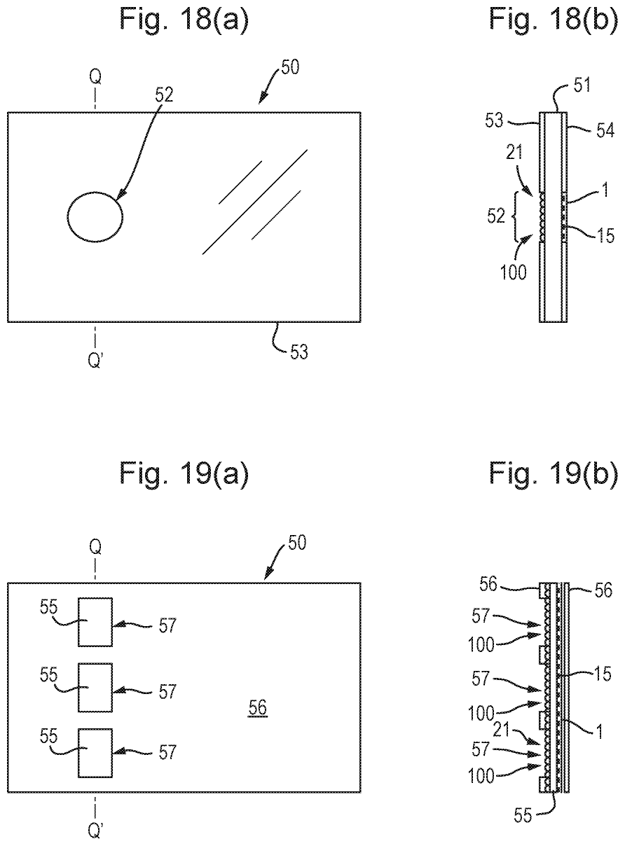

Examples of such documents of value and techniques for incorporating a security device will now be described with reference to FIGS. 18 to 21.

FIG. 18 depicts an exemplary document of value 50, here in the form of a banknote. FIG. 18(a) shows the banknote in plan view whilst FIG. 18(b) shows a cross-section of the same banknote along the lines Q-Q′. In this case, the banknote is a polymer (or hybrid polymer/paper) banknote, having a transparent substrate 51. Two opacifying layers 53 and 54 are applied to either side of the transparent substrate 51, which may take the form of opacifying coatings such as white ink, or could be paper layers laminated to the substrate 51.

The opacifying layers 53 and 54 are omitted across a selected region 52 forming a window within which a security device is located. In FIG. 18(b), the security device is disposed within window 52, with a focusing element array 21 arranged on one surface of the transparent substrate 51, and masking layer 15 and decorative layer 1 on the other, thus forming device 100.

It will be appreciated that, if desired, the window 52 could instead be a “half-window”, in which opacifying layer 54 is continued over all or part of the masking layer and decorative layer. Depending on the opacity of the opacifying layers, the half-window region will tend to appear translucent relative to surrounding areas in which opacifying layers 53 and 54 are provided on both sides.

In FIG. 19 the banknote 50 is a conventional paper-based banknote provided with a security article 55 in the form of a security thread, which is inserted during paper-making such that it is partially embedded into the paper so that portions of the paper 56 lie on either side of the thread. This can be done using the techniques described in EP0059056 where paper is not formed in the window regions during the paper making process thus exposing the security thread 55 in window regions 57 of the banknote. Alternatively the window regions 57 may for example be formed by abrading the surface of the paper in these regions after insertion of the thread. Here, the window regions 57 are “half thickness” windows, meaning that the thread 55 is only exposed on one surface of the banknote. It should be noted that the window regions 57 may be “full thickness” windows where the thread 55 is exposed on both surfaces if preferred. The security device 100 is formed on the thread 55, which comprises a transparent substrate, a focusing array 21 provided on one side and the masking layer and decorative layer provided on the other. Windows 57 reveal parts of the device, which may be formed continuously along the thread, as illustrated in FIG. 19(b). Alternatively several security devices could be spaced from each other along the thread, with different or identical images displayed by each.

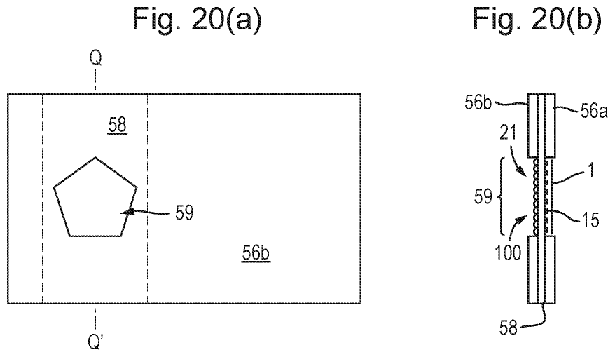

In FIG. 20, the banknote 50 is again a conventional paper-based banknote, provided with a strip element or insert 58. The strip 58 is based on a transparent substrate and is inserted between two plies of paper 56a and 56b. The security device 100 is formed by a lens array 21 on one side of the strip substrate, and masking layer 15 and decorative layer 1 on the other. The paper plies 56a and 56b are apertured across region 59 to reveal the security device, which in this case may be present across the whole of the strip 58 or could be localised within the aperture region 59, as in FIG. 19(b). It should be noted that the ply 56a need not be apertured and could be continuous across the security device.

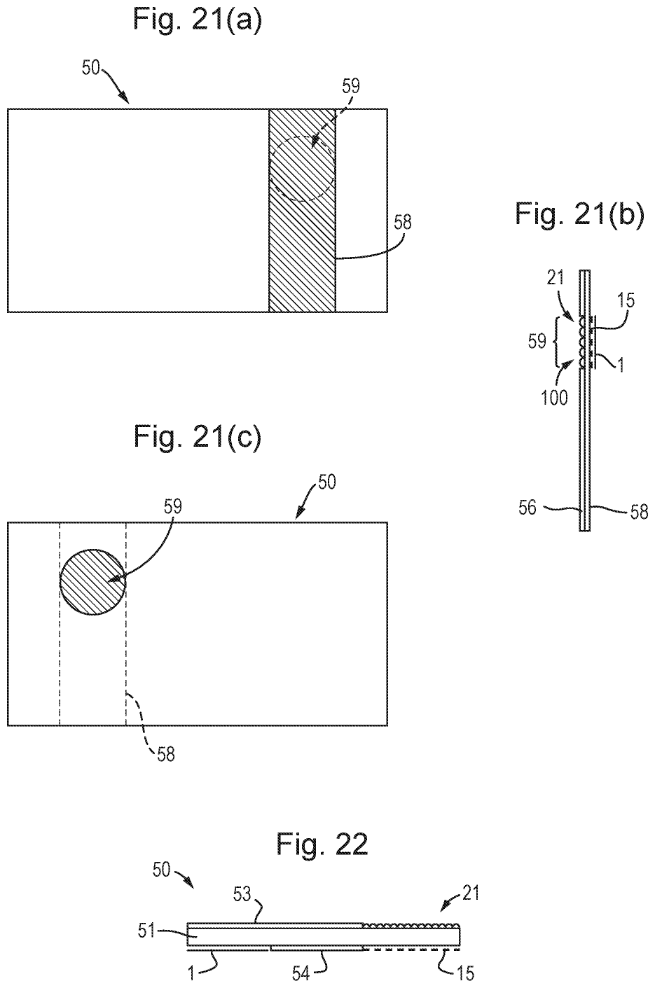

A further embodiment is shown in FIG. 21 where FIGS. 21(a) and (b) show the front and rear sides of the document 50 respectively, and FIG. 21(c) is a cross section along line Q-Q′. Security article 58 is a strip or band comprising a security device according to any of the embodiments described above. The security article 58 is formed into a security document 50 comprising a fibrous substrate 56, using a method described in EP-A-1141480. The strip is incorporated into the security document such that it is fully exposed on one side of the document (FIG. 21(a)) and exposed in one or more windows 59 on the opposite side of the document (FIG. 21(b)). Again, the security device is formed on the strip 58, which comprises a transparent substrate with a lens array 21 formed on one surface and a co-operating masking layer 15 and decorative layer 1 as previously described on the other

Alternatively a similar construction can be achieved by providing paper 56 with an aperture 59 and adhering the strip element 58 onto one side of the paper 56 across the aperture 59. The aperture may be formed during papermaking or after papermaking for example by die-cutting or laser cutting.

In still further embodiments, a complete security device could be formed entirely on one surface of a security document which could be transparent, translucent or opaque.

FIG. 22 illustrates a further embodiment of the present invention. Here, the decorative layer 1 is located separately to the masking layer 15 and array of focussing elements 21. In this particular embodiment, the decorative layer 1 is printed on a different part of a banknote 50 to the masking layer and focussing element array. When the banknote 50 is folded over, the complete security device 100 is formed, with the decorative layer 1, masking layer 15 and focussing element array 21 cooperating to exhibit the visual effects described above. In the example of FIG. 22, the banknote is a polymer banknote having opacifying layers 53, 54 defining a window region in which the complete security device may be viewed. In other alternative embodiments, the decorative layer 1 may be provided on a separate security document.

The security device of the current invention can be made machine readable by the introduction of detectable materials in any of the layers or by the introduction of separate machine-readable layers. Detectable materials that react to an external stimulus include but are not limited to thermochromic, photochromic, magnetic, electrochromic, conductive and piezochromic materials.

1. A security device comprising:
a decorative layer comprising a luminescent material arranged in a first region, wherein the luminescent material luminesces in response to irradiation at at least one excitation wavelength such that the first region exhibits a luminescent visible colour when illuminated by said at least one excitation wavelength;
an array of viewing elements; and,
a masking layer comprising masking material positioned between the decorative layer and the array of viewing elements, the masking layer arranged as an array of pattern elements at least partially overlapping with said first region, and comprising first pattern elements defined by the presence of the masking material, and second pattern elements defined by the absence of the masking material such that the decorative layer is visible through the second pattern elements, wherein;
the masking material is non-luminescing in response to the at least one excitation wavelength and is such that,
when the security device is illuminated in the absence of the at least one excitation wavelength, at least where the array of pattern elements overlaps with the first region the first and second pattern elements have substantially the same visual appearance, and
when the security device is illuminated by said at least one excitation wavelength, where the array of pattern elements overlaps with the first region, the second pattern elements exhibit the luminescent visible colour, and the first pattern elements exhibit a visual appearance that is different to the luminescent visible colour; and wherein,
the array of pattern elements cooperates with the array of viewing elements such that when the security device is illuminated with the at least one excitation wavelength, the security device exhibits an optically variable effect.

2. The security device of claim 1, wherein, when illuminated in the absence of the at least one excitation wavelength, the first region exhibits a non-luminescent visible colour.

3. The security device of claim 2, wherein the non-luminescent visible colour exhibited by the first region when illuminated in the absence of the at least one excitation wavelength is different to the luminescent visible colour exhibited by the first region when illuminated by said at least one excitation wavelength.

4. The security device of claim 1, wherein, when illuminated in the absence of the at least one excitation wavelength, the first region is substantially colourless.

5. The security device of claim 1 wherein, when the masking material is illuminated in the absence of the at least one excitation wavelength, the masking material is substantially transparent and substantially colourless such that the decorative layer is visible through the first pattern elements.

6. The security device of any of claim 2, wherein each first pattern element is arranged laterally within the first region and, when illuminated in the absence of the at least one excitation wavelength, the masking material exhibits a non-luminescent visible colour that is substantially the same as the non-luminescent visible colour exhibited by the first region in the absence of the at least one excitation wavelength.

7. A security device comprising:
a decorative layer comprising a luminescent material arranged in a first region, wherein the luminescent material luminesces in response to irradiation at at least one excitation wavelength such that the first region exhibits a luminescent visible colour when illuminated by said at least one excitation wavelength;
an array of viewing elements; and,
a masking layer comprising masking material positioned between the decorative layer and the array of viewing elements, the masking layer arranged as an array of pattern elements at least partially overlapping with said first region, and comprising first pattern elements defined by the presence of the masking material, and second pattern elements defined by the absence of the masking material such that the decorative layer is visible through the second pattern elements, wherein;
the masking material exhibits a non-luminescent visible colour when illuminated in the absence of said at least one excitation wavelength, and is non-luminescing in response to the at least one excitation wavelength, and wherein,
when the security device is illuminated in the absence of the at least one excitation wavelength, in at least one part of the security device, the first pattern elements exhibit a visual appearance that is different to a visual appearance exhibited by the second pattern elements, whereby the array of pattern elements cooperates with the array of viewing elements such that the security device exhibits a first optically variable effect, and,
when the security device is illuminated by said at least one excitation wavelength, where the array of pattern elements overlaps with the first region, the second pattern elements exhibit the luminescent visible colour, and the first pattern elements exhibit a visual appearance that is different to the luminescent visible colour, whereby the array of pattern elements cooperates with the array of viewing elements such that the security device exhibits a second optically variable effect; and wherein,
the arrangement of the first region and the array of pattern elements is such that the first optically variable effect conveys first information, and the second optically variable effect conveys second information that is different to the first information.

8. The security device of claim 7, wherein the array of pattern elements defines a second region, wherein the pattern elements within the second region cooperate with the array of viewing elements to exhibit an optically variable effect, and wherein either: (i) the second region is laterally completely contained within the first region, and further wherein the first region exhibits a non-luminescent visible colour that is different to the non-luminescent visible colour exhibited by the masking material; or (ii) the second region laterally extends beyond the first region in at least a part of the device.

9.-13. (canceled)

14. The security device of claim 7, wherein the masking layer comprises at least first and second masking materials such that some first pattern elements comprise the first masking material and some first pattern elements comprise the second masking material, the first and second masking materials having different optical properties when illuminated in the absence of the at least one excitation wavelength.

15. The security device of claim 1, wherein the decorative layer comprises an ink arranged in said first region, the ink comprising said luminescent material.

16. The security device of claim 15, wherein the ink further comprises an optically detectable material that exhibits a non-luminescent visible colour when illuminated in the absence of the at least one excitation wavelength.

17. The security device of claim 8, wherein the first region is in the form of indicia or an indicium; wherein the second region is in the form of indicia or an indicium, and wherein the first and second regions complement each other.

18.-24. (canceled)

25. The security device of claim 1, wherein the masking material substantially absorbs radiation of the at least one excitation wavelength.

26. (canceled)

27. The security device of claim 1, wherein the masking material is an ink.

28. The security device of claim 1, wherein the at least one excitation wavelength is at least one UV wavelength in the range of 200 nm to 400 nm, or wherein the at least one excitation wavelength is substantially any UV wavelength in the range of 200 nm to 400 nm.

29.-40. (canceled)

41. The security device of claim 1, wherein, when the security device is illuminated in the absence of the at least one excitation wavelength, the security device conveys a first piece of information, and wherein the optically variable effect exhibited by the device when illuminated by the said at least one excitation wavelength conveys a second piece of information, the first piece of information being different to the second piece of information.

42. The security device of claim 1, wherein the array of viewing elements comprises an array of focussing elements.

43.-48. (canceled)

49. A method of manufacturing a security device, comprising:
(i) providing a substantially transparent substrate; and,
(ii) applying a masking layer, decorative layer and an array of viewing elements to the substrate such that the masking layer is positioned between the decorative layer and the array of viewing elements, and the array of viewing elements overlaps with the masking layer, and wherein;
the decorative layer comprises a luminescent material arranged in a first region, wherein the luminescent material luminesces in response to irradiation at at least one excitation wavelength such that the first region exhibits a luminescent visible colour when illuminated by said at least one excitation wavelength;
the masking layer comprises masking material and is arranged as an array of pattern elements at least partially overlapping with said first region, and comprises first pattern elements defined by the presence of the masking material, and second pattern elements defined by the absence of the masking material such that the decorative layer is visible through the second pattern elements, wherein;
the masking material is non-luminescing in response to the at least one excitation wavelength and is such that,
when the security device is illuminated in the absence of the at least one excitation wavelength, the first and second pattern elements have substantially the same visual appearance, and
when the security device is illuminated by said at least one excitation wavelength, where the array of pattern elements overlaps with the first region, the second pattern elements exhibit the luminescent visible colour, and the first pattern elements exhibit a visual appearance that is different to the luminescent visible colour; and wherein,
the array of pattern elements cooperates with the array of viewing elements such that when the security device is illuminated with the at least one excitation wavelength, the security device exhibits an optically variable effect.

50. (canceled)

51. A method of manufacturing a security device, comprising:
(i) providing a substantially transparent substrate; and,
(ii) applying a masking layer, decorative layer and an array of viewing elements to the substrate such that the masking layer is positioned between the decorative layer and the array of viewing elements, and the array of viewing elements overlaps with the masking layer, and wherein;
the decorative layer comprises a luminescent material arranged in a first region, wherein the luminescent material luminesces in response to irradiation at at least one excitation wavelength such that the first region exhibits a luminescent visible colour when illuminated by said at least one excitation wavelength;
the masking layer comprises masking material and is arranged as an array of pattern elements at least partially overlapping with said first region, and comprises first pattern elements defined by the presence of the masking material, and second pattern elements defined by the absence of the masking material such that the decorative layer is visible through the second pattern elements, wherein;
the masking material exhibits a non-luminescent visible colour when illuminated in the absence of said at least one excitation wavelength and is non-luminescing in response to the at least one excitation wavelength, and wherein,
when the security device is illuminated in the absence of the at least one excitation wavelength, in at least one part of the security device, the first pattern elements exhibit a visual appearance that is different to a visual appearance exhibited by the second pattern elements, whereby the array of pattern elements cooperates with the array of viewing elements such that the security device exhibits a first optically variable effect, and,
when the security device is illuminated by said at least one excitation wavelength, where the array of pattern elements overlaps with the first region, the second pattern elements exhibit the luminescent visible colour, and the first pattern elements exhibit a visual appearance that is different to the luminescent visible colour, whereby the array of pattern elements cooperates with the array of viewing elements such that the security device exhibits a second optically variable effect; and wherein,
the arrangement of the first region and the array of pattern elements is such that the first optically variable effect conveys first information, and the second optically variable effect conveys second information that is different to the first information.

52.-62. (canceled)

63. A security document or security article comprising a security device according to claim 1.

64. A security arrangement comprising:
a security document that comprises a masking layer and an array of viewing elements; and
a decorative layer; wherein
the decorative layer may be arranged with the masking layer and array of viewing elements to form a security device according to claim 1.

65.-66. (canceled)
